(19) United States
(12) Patent Application Publication
(10) Pub. No.: US 2009/0142682 A1
(43) Pub. Date: Jun. 4, 2009

(54) TONER, METHOD OF MANUFACTURING TONER AND IMAGE FORMATION METHOD

(76) Inventors: Akinori Saitoh, Numazu-shi (JP); Osamu Uchinokura, Mishima-shi (JP); Masahide Yamada, Numazu-shi (JP); Tomomi Suzuki, Numazu-shi (JP); Junichi Awamura, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/325,660

(22) Filed: Dec. 1, 2008

(30) Foreign Application Priority Data
Nov. 29, 2007 (JP) 2007-308612

(51) Int. Cl. G03G 9/08; G03G 9/087; G03G 21/06

(52) U.S. Cl. 430/108.2; 430/111.4; 430/110.4; 430/109.4; 430/137.1; 430/119.82

(57) ABSTRACT

A toner including a binder resin, a coloring agent, a releasing agent and a modified laminar inorganic mineral, wherein the toner is granulated by dispersing the coloring agent, the releasing agent, the modified laminar inorganic mineral and at least one of the binder resin and a precursor thereof in an organic solvent to form an oil phase, dispersing the oil phase in an aqueous medium to obtain a dispersion emulsion and removing solvents therefrom, and the toner satisfies the following relationship (1): 0.2≦{1/Dv (μm)}×Sb (m²/g)≦1.4, where Dv represents a volume average particle diameter of the toner, and Sb represents a BET specific surface area of the toner.

### BACKGROUND OF THE INVENTION

1. Field of the Invention

The present invention relates to a toner, a method of manufacturing the toner, and an image formation method using the toner.

2. Discussion of the Background

In recent years, demand for quality images from the market has spurred development of suitable electrophotographic apparatuses and developing agents including toner for use therein. Toner capable of producing quality images is required to have a sharp particle size distribution. Toner particles of toner having a sharp particle size distribution behave in keeping with each other during development, which improves minute dot reproducibility.

However, toner having a small particle diameter with a sharp particle size distribution has a problem with regard to cleaning property. Stably removing such toner with a cleaning blade is especially difficult. Therefore, various kinds of methods of improving the cleaning property of toner have been developed by devising toner. Among them, a method of irregularizing the form of toner having a spherical form is disclosed. This method reduces the powder fluidity of toner so that the toner is easily dammed by a cleaning blade. However, when toner is excessively irregularized, the behavior of the toner during development tends to be unstable, which leads to deterioration of minute dot reproducibility.

As described above, irregularization of toner form has an impact on improvement of the cleaning property of toner. However, the fixing property thereof deteriorates. That is, when the toner form is irregularized, the filling density of toner in the toner layer on a recording medium before fixing becomes small, which slows down the heat conduction speed in the toner layer during fixing. Thereby, the low temperature fixing property deteriorates. The heat conductivity worsens when the pressure during fixing is relatively small in comparison with a typical case, resulting in deterioration of low temperature fixing property.

Unexamined published Japanese patent application No. (hereinafter referred to as JOP) describes toner made of a polyester having a Wadell's working sphericity of from 0.90 to 1.00 but this toner is substantially spherical so that the issue of the cleaning property of toner described above is not solved.

Methods of manufacturing polymerization toner includes an emulsification polymerization method or a dissolution suspension method in which irregularization of toner is relatively easy, in addition to a suspension polymerization method. However, removing an emulsification agent, a dispersion agent and a styrene monomer completely is difficult even in the emulsification polymerization method. Furthermore, as the environment is an issue these days, the requirement for toner becomes severe. When toner has a rough form, silica added as a fluidizer is not easily attached to the concave portions and transfer of silica to the concave portions during use tends to cause contamination of a photoreceptor and a toner attachment problem.

Additionally, the dissolution suspension method has an advantage that a polyester resin, which is suitable for low temperature fixing, can be used. However, the liquid viscosity increases by polymer control for improving releasing property and an addition of polymer component in the dissolution and/or dispersion process in which a resin or a coloring agent is dissolved or dispersed in a solvent during production. This tends to cause a problem in light of manufacturing and such a manufacturing problem has not been solved. JOP H09-15903 describes a technology of a dissolution suspension method in which the form of toner is made to be spherical and rough to improve the cleaning property. Since the obtained toner has an irregular form, the chargeability thereof is unstable. Furthermore, polymer content for securing fundamental durability and releasability is not designed. As a result, the obtained toner is not satisfying in terms of the quality of toner.

Recently, JOP 2005-49858 describes a technology using resin particles for toner having a form suitable for blade cleaning and a wide temperature range for the fixing temperature. But actually, the toner does not have a sufficiently good combination of the cleaning property and the low temperature fixing property.

### SUMMARY OF THE INVENTION

Because of these reasons, the present inventors recognize that a need exists for a toner having reliable and stable cleaning property, good low temperature fixing property, good transfer efficiency with less amount of residual toner remaining on an image bearing member, a good combination of charging stability and/or low temperature fixing property and a good combination of a high transferability for a color image and a transmissive property for transparent sheets with a less consumption of power, a method of manufacturing the toner and an image formation method using the toner.

Accordingly, an object of the present invention is to provide a toner having reliable and stable cleaning property, good low temperature fixing property, good transfer efficiency with less amount of residual toner remaining on an image bearing member, a good combination of charging stability and/or low temperature fixing property and a good combination of a high transferability for a color image and a transmissive property for transparent sheets with a less consumption of power, a method of manufacturing the toner and an image formation method using the toner.

Briefly this object and other objects of the present invention as hereinafter described will become more readily apparent and can be attained, either individually or in combination thereof, by a toner including a binder resin, a coloring agent, a releasing agent and a modified laminar inorganic mineral, wherein the toner is granulated by dispersing the coloring agent, the releasing agent, the modified laminar inorganic mineral and at least one of the binder resin and a precursor thereof in an organic solvent to form an oil phase, dispersing the oil phase in an aqueous medium to obtain a dispersion emulsion and removing solvents therefrom, and wherein the toner satisfies the following relationship (1): 0.2≦{1/Dv (μm)}×Sb (m2/g)≦1.4. In Relationship (1), Dv represents a volume average particle diameter of the toner, and Sb represents a BET specific surface area of the toner.

It is preferred that, in the toner mentioned above, the oil phase includes a complex of kneaded mixture of the releasing agent and the modified laminar inorganic mineral.

It is still further preferred that the toner mentioned above has a BET specific surface area is from 1.0 to 7.0 m²/g.

It is still further preferred that the toner mentioned above has a volume average particle diameter is from 3 to 7 μm.

It is still further preferred that, in the toner mentioned above, the modified laminar inorganic mineral in the complex has a volume average diameter Dv of from 0.1 to 0.55 μm and the modified laminar inorganic mineral having a particle diameter of not less than 1 μm in the complex is not greater than 15% by volume.

It is still further preferred that, in the toner mentioned above, the content of the modified laminate mineral inorganic mineral is 0.1 to 5% by weight based on the toner.

It is still further preferred that, in the toner mentioned above, organic ions for use in modification of the modified laminar inorganic mineral is quaternary ammonium ion.

It is still further preferred that, in the toner mentioned above, the ratio (Dv/Dn) of the volume average particle diameter Dv to a number average particle diameter Dn is not greater than 1.20.

It is still further preferred that, in the toner mentioned above, toner particles having a particle diameter of not greater than 2 μm in an amount of from 1 to 10% by number.

It is still further preferred that, in the toner mentioned above, the binder resin comprises a polyester resin.

It is still further preferred that, in the toner mentioned above, the content of the polyester resin in the binder resin is from 50 to 100% by weight.

It is still further preferred that, in the toner mentioned above, the polyester resin includes a portion soluble in tetrahydrofuran (THF) which has a weight average molecular weight of from 1,000 to 30,000.

It is still further preferred that, in the toner mentioned above, the polyester resin has an acid value of from 1.0 to 50.0 mgKOH/g.

It is still further preferred that, in the toner mentioned above, the polyester resin has a glass transition temperature of from 35 to 65° C.

It is still further preferred that, in the toner mentioned above, the precursor has a weight average molecular weight is from 3,000 to 20,000.

It is still further preferred that the toner mentioned above has a glass transition temperature of from 40 to 70° C.

It is still further preferred that the toner mentioned above is for use in a two component developing agent.

As another aspect of the present invention, a method of manufacturing the toner mentioned above is provided which includes dispersing a coloring agent, a releasing agent, a modified laminar inorganic mineral and at least one of a binder resin and a precursor thereof in an organic solvent to obtain an oil phase comprising a liquid dispersion, dispersing the oil phase in an aqueous medium to obtain a dispersion emulsion and removing a solvent from the dispersion emulsion to granulate toner particles.

As another aspect of the present invention, an image formation method is provided which includes charging an image bearing member to uniformly charge the surface thereof, irradiating the surface of the image bearing member with light to form a latent electrostatic image thereon, developing the latent electrostatic image with the toner mentioned above to form a toner image on the surface of the image bearing member, transferring the toner image borne on the image bearing member to a transfer medium and removing the toner remaining on the surface of the image bearing member with a blade.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating a cross section of an example of an image forming apparatus; and

FIG. 2 is a diagram illustrating the structure of a process cartridge.

### DETAILED DESCRIPTION OF THE INVENTION

The present invention will be described below in detail with reference to several embodiments and accompanying drawings.

The toner of the present invention satisfies the following relationship (1):

0.2≦{1/Dv (μm)}×S_{b} (m²/g)≦1.4 Relationship (1)

where Dv represents a volume average particle diameter of the toner, and Sb represents a BET specific surface area of the toner.

When the relationship (1) is not satisfied, the quality of image tends to deteriorate due to bad transfer and encapsulation of an additive.

The toner of the present invention has a ratio (Dv/Dn) of the volume average particle diameter (Dv) to the number average particle diameter (Dn) of from 1.00 to 1.30. This makes the toner of the present invention suitable for obtaining quality images with a high definition. Furthermore, when the toner is used in a two component developing agent and replenished for an extended period of time, the variance of the particle diameter of the toner in the developing agent is reduced. Also good developability is maintained even when the toner is repeatedly stirred in a development device for an extended period of time. When the ratio (Dv/Dn) is too large, particles diameters of individual toner particles greatly vary, thereby making the behavior of the toner vary during development and degrading the reproducibility of minute dots. Therefore, quality images are not obtained. The ratio (Dv/Dn) is preferably from 1.00 to 1.20, which ameliorates the quality of images.

The toner of the present invention preferably has a volume average particle diameter of from 3.0 to 7.0 μm. In general, toner having a small particle diameter is advantageous to obtain quality images with a high definition but disadvantageous in terms of the transferability and the cleaning property. When toner has an excessively small volume average particle diameter, the toner in a two component developing agent tends to adhere to the surface of carrier particles during stirring in the development device for an extended period of time, resulting in deterioration of chargeability of the carrier. When the toner is used as a single component developing agent, filming of toner on the development roller and adhesion of the toner to a member such as a blade for regulating the toner layer thickness tend to occur. Furthermore, these phenomena relate to the content ratio of fine powder. When toner particles having a particle diameter of not greater than 2 μm are contained in an amount of not less than 10% by number, such toner easily attaches to carrier particles and has a negative impact on stabilization of chargeability at a high level. To the contrary, when the toner particle diameter is too large, quality images with high definition tend to be hardly obtained and the particle diameter of toner tends to greatly vary when the toner is replenished. Additionally, it is found that this is true when the ratio (Dv/Dn) is too large.

The toner of the present invention preferably has a BET specific surface area of from 1.0 to 7.0 (m²/g). When the BET specific surface area of the toner is too small, the existence of coarse particles and encapsulation of additives negatively affect the quality of images. When the BET specific surface area of the toner is too large, the existence of fine particles, additives floating to the surface and roughened surface of the toner particle negatively affects the quality of images.

BET specific surface area of the toner of the present invention is represented by the ratio (S_{b}/Sₜ) of S_{b} (m²/g) representing the specific surface area per weight unit measured by BET method to Sₜ (m²/g) representing the specific surface area per weight unit measured by BET method calculated based on the weight average particle diameter assuming that the toner is a true sphere.

The BET specific surface area is measured by the multipoint method of nitrogen absorption method using high speed ratio specific surface area micropore distribution measuring device NOVA 1200 (manufactured by Yuasa Ionics Inc.)

Measuring conditions are as follows:

Absorption gas: Nitrogen gas (99.995 or more)

Cooling medium: Liquid nitrogen

Cell: 9 mm pellet short (large)

Pre-treatment condition: 30° C., 12 hours (vacuum evacuated)

Measured points: 3 points having a relative pressure (P/PO) of from 0.1 to 0.3

As described above, toner having a small particle diameter with a sharp particle size distribution has a problem with the cleaning property. Therefore, toner having a shape factor SF-1 of from 110 to 200 and a shape factor SF-2 of from 110 to 300 is preferred.

The relationship between the toner shape and the transferability is described first. When a full color photocopier is used in which multicolor images are transferred, the amount of toner on the image bearing member increases in comparison with the case in which a single color (black) photocopying toner is used in a monochrome photocopier. Thus, it is difficult to improve the transfer efficiency by simply using a typical irregularized toner. Furthermore, a typical irregularized toner tends to cause adhesion to or filming on the surface of an image bearing member and/or an intermediate transfer body due to a shear stress or abrasion force between the image bearing member and a cleaning member, between an intermediate transfer body and a cleaning member, and/or between the image bearing member and the intermediate transfer body, which leads to deterioration of the transfer efficiency. When a full color image is formed, a four color toner image is hardly uniformly transferred. Furthermore, when an intermediate transfer body is used, problems such as color unevenness and color balance tend to arise, resulting in difficulty in continuous production of quality full color images.

Toner having a shape factor SF-1 of from 110 to 200 and preferably from 120 to 180 is preferred in terms of the balance between blade cleaning and transfer efficiency. Cleaning and transfer efficiency greatly relate to blade materials and contact condition of a blade. In addition, since transfer varies depending on process conditions, toner can be suitably designed in the range of SF-1 specified above. When SF-1 is too small, blade cleaning is hardly effective. When SF-1 is too large, the transferability described above tends to deteriorate. This phenomenon is considered to occur because the toner has an irregular form so that the toner does not move smoothly during transfer (from the surface of an image bearing member to a transfer medium, the surface of an image bearing member to an intermediate transfer belt, a primary intermediate transfer belt to a secondary intermediate transfer belt, etc.) and the behavior among toner particles varies, resulting in non-uniform and low transfer efficiency. Furthermore, charging of toner starts to be unstable and the toner particles tend to be brittle. In addition, toner particles in a developing agent tend to be broken into fine powder, which may cause deterioration of durability of the developing agent.

Pulverized toner has an irregular form (not having a particularly regular form or a round shape) with a shape factor SF-1 of 140 or higher. Since the particle size distribution of pulverized toner is broad in general, manufacturing pulverized toner is not efficient to obtain toner having a ratio (Dv/Dn) of 1.30 or lower. It is not possible to ameliorate low temperature fixing property of toner by a polymerization method because a polyester-based toner is difficult to manufacture by a suspension polymerization method, an emulsification polymerization, etc. JOPs H11-149180 and 2000-292981 describe a toner in which a toner binder manufactured by elongation reaction and/or cross-linking reaction of a prepolymer A having an isocyanate group and a coloring agent are included and toner particles are formed by elongation reaction and/or cross-linking reaction of the prepolymer A by an amine B in an aqueous medium, and a manufacturing method of the toner. However, since the toner does not have the same form as that of the toner of the present invention, the toner does not have a good combination of transfer property and cleaning property.

The present invention preferably has a process of mixing and kneading a binder resin and a laminate inorganic mineral having ions in which at least part of the ions are modified by an organic ion to obtain a complex of kneaded mixture and a process of dissolving and dispersing the complex of kneaded mixture in an oil phase (i.e., the oil phase contains the complex) to suitably disperse the laminate inorganic mineral in toner in the manufacturing method using the reaction of the prepolymer A and the amine B mentioned above. Therefore, a toner having a shape factor SF-1 of from 110 to 200 and a shape factor SF-2 of from 110 to 300 can be easily obtained in the present invention. Different from the present invention, a typically employed suspension polymerization method or emulsification polymerization method has difficulty in controlling toner shape.

In this specification, the laminate inorganic mineral having ions in which at least part of the ions are modified by an organic ion is referred to as modified laminar inorganic mineral.

Below is a description about the method of measuring characteristics of the toner of the present invention.

### Toner Form

The shape factors SF-1 and SF-2, the circularity for use in the present invention, are obtained as follows: randomly sampling 300 SEM images measured by FE-SEM (S-4200, manufactured by Hitachi Ltd.); introducing the image information to an image analyzer (LuzexAP, manufactured by Nireco Corporation) via an interface for analysis; and calculating the values according to the following relationships, which are defined as SF-1 and SF-2. Although the values of SF-1 and SF-2 are preferably obtained by Luzex, any other FE-SEM devices and image analyzers can be used as long as the same analysis result can be obtained.

SF-1=(L2/A)×(π/4)×100

SF-2=(P2/A)×(1/4π)×100

In the relationships, L represents the absolute maximum length of toner, A represents projected area of toner, and P represents the maximum circumference.

The values of SF-1 and SF-2 of a true sphere are 100. As the value increases away from 100, the form is away from a sphere. SF-1 represents the entire form such as ellipse or sphere of toner and SF-2 represents the degree of roughness of the surface thereof.

### Toner Particle Size

The average particle diameter and size distribution of a toner can be measured by Coulter Counter method.

Specific examples of devices measuring particle size distribution of toner particles include COULTER COUNTER TA-II and COULTER MULTI-SIZER II (both are manufactured by Beckman Coulter Inc.). COULTER COUNTER MULTI-SIZER TA-II is connected to an interface (manufactured by the institute of Japanese Union of Science and Engineers) and a PC9801 personal computer (manufactured by NEC Corporation) to measure the number distribution and the volume distribution.

The measuring method is described below.

(1) Add 0.1 to 5 ml of a surface active agent (preferably a salt of an alkyl benzene sulfide) as a dispersing agent to 100 to 150 ml of an electrolytic aqueous solution. The electrolytic aqueous solution is an about 1% NaCl aqueous solution prepared by using primary NaCl (e.g., ISOTON-II®, manufactured by Beckman Coulter Inc.).

(2) Add 2 to 20 mg of a measuring sample to the electrolytic aqueous solution.

(3) The electrolytic aqueous solution in which the measuring sample is suspended is subject to a dispersion treatment for about 1 to 3 minutes with an ultrasonic disperser.

(4) Measure the volume and the number of toner particles or toner with the aperture set to 100 μm for the measuring device mentioned above to calculate the volume distribution and the number distribution.

The whole range is a particle diameter of from 2.00 to not greater than 40.30 μm and the number of the channels is 13. These channels are: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm. The volume average particle diameter (Dv) based on volume obtained by the volume distribution and the number average particle diameter (Dn) obtained by the number distribution related to the present invention, and the ratio thereof (Dv/Dn) are obtained.

### Particle Having Particle Diameter of 2 μm or Less

The particle ratio of the toner having a particle diameter of 2 μm or less and the average circularity thereof can be measured by using a flow particle image analyzer (FPIA-1000, manufactured by Sysmex Corporation). A specific method is: Add 0.1 to 0.5 ml of a surface active agent, preferably, alkylbenzene sulfonate salt, to 100 to 150 ml of water in a container from which impurity has been removed in advance; Add about 0.1 to about 0.5 g of a sample material thereto to obtain a liquid suspension in which the sample material is dispersed; subsequent to about 1 to 3 minutes dispersion treatment of the liquid suspension by an ultrasonic dispersing device, measure the form and distribution of the toner by the device specified above while the density of the liquid dispersion is presumed to be 3,000 to 10,000 particles/μl.

According to a further study about the present invention, it is preferred to use a polyester resin as a binder resin to maintain a high temperature preservability, effectively demonstrate a low temperature fixing property and impart anti-offset property after modification by a prepolymer, and the weight average molecular weight of the portion of the polyester resin which is soluble in THF is preferably from 1,000 to 30,000. When the weight average particle diameter is less than 1,000, the olygomer component tends to increase, which leads to deterioration of high temperature preservability. When the weight average molecular weight is too large, modification by the prepolymer is insufficient due to steric barrier, resulting in deterioration of anti-offset property.

The molecular weight can be measured by gel permeation chromatography (GPC) as follows: Stabilize a column in a heat chamber at 40° C.; Flow tetrahydrofuran (THF) at this temperature at 1 ml/min as a column solvent; Fill 50 to 200 μl of a tetrahydrofuran sample solution of a resin which is prepared to have a sample density of 0.05 to 0.6 weight % for measurement. The molecular weight distribution of the sample is calculated by comparing the logarithm values and the count values of the analytical curves obtained from several kinds of single dispersion polystyrene standard sample. Specific examples of the standard polystyrene samples for the analytical curves include polystyrenes having a molecular weight of 6×10², 2.1×10³, 4×10³, 1.75×10⁴, 5.1×10⁴, 1.1×10⁵, 3.9×10⁵, 8.6×10⁵, 2×10⁶ and 4.48×10⁶, manufactured by Pressure Chemical Co., or Tosoh Corporation. It is preferred to use at least about ten standard polystyrene samples. A refractive index (RI) detector can be used as the detector.

Toner characteristics such as particle size control by addition of a base compound, low temperature fixing property, hot offset resistance property, high temperature preservability, charging stability can be improved by setting the acid value of the polyester resin in the range of from 1.0 to 50.0 mgKOH/g. When the acid value is too high, elongation or cross-linking reaction of a modified polyester tends to be insufficient, which has an adverse impact on anti-hot offset property. When the acid value is too low, a base compound cannot easily provide the dispersion stability effect during manufacturing and the modified polyester resin easily conducts the elongation and cross-linking reaction, which causes a problem of manufacturing stability.

The acid value of the polyester resin for use in the present invention is measured according to JIS K0070. When a sample is not dissolved, a solvent such as dioxane or THF is used.

The acid value is specifically determined according to the following procedure.
Measuring device: automatic potentiometric titrator (DL-53 Titrator manufactured by Mettler Toledo International Inc.)
Electrode: DG113-SC (manufactured by Mettler Toledo International Inc.)
Analysis software: LabX Light Version 1.00.000
Calibration: use a solvent mixture of 120 ml of toluene and 30 ml of ethanol
Measuring temperature: 23° C.

The measuring conditions are as follows.

Stir

| | |
|---|---|
| Speed [%] | 25 |
| Time [s] | 15 |

EQP titration
Titrant/Sensor

| | |
|---|---|
| Titrant | CH₃ONa |
| Concentration [mol/L] | 0.1 |
| Sensor | DG115 |
| Unit of measurement | mV |

Predispensing to volume

| | |
|---|---|
| Volume [mL] | 1.0 |
| Wait time [s] | 0 |

Titrant addition Dynamic

| | |
|---|---|
| dE(set) [mV] | 8.0 |
| dV(min) [mL] | 0.03 |
| dV(max) [mL] | 0.5 |

Measure mode Equilibrium controlled

| | |
|---|---|
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. termination conditions | No |

Evaluation
Procedure Standard

| | |
|---|---|
| Potential 1 | No |
| Potential 2 | No |
| Stop for reevaluation | No |

### Method of Measuring Acid Value

The acid value is measured according to the measuring method described in JIS K0070-1992.

Sample adjustment: 0.5 g of polyester (the composition soluble in ethyl acetate: 0.3 g) is added to 120 ml of toluene and the mixture is stirred at room temperature (23° C.) for about 10 hours to dissolve the polyester. 30 ml of ethanol is added thereto to prepare a sample solution.

The acid value can be measured by the device described in JIS K0070-1992 and calculated specifically as follows:

Preliminarily standardized N/10 caustic potash-alcohol solution is used for titration and the acid is calculated from the consumed amount of the caustic potash-alcohol solution based on the following relationship:

Acid value=KOH (ml)×N×56.1/(weight of sample material), where N represents the factor in N/10 KOH

In the present invention, the high temperature preservability of the modified polyester resin, i.e., the main component of a binder resin, depends on the glass transition temperature of the polyester resin before modification. The glass transition temperature of the polyester resin is preferably designed to be in the range of from 35 to 65° C. That is, when the glass transition temperature is too low, the anti-high temperature preservability tends to be insufficient. A glass transition temperature that is too high tends to have an adverse impact on the low temperature fixing property.

In the present invention, the glass transition temperature can be measured by the following method in which, for example, TG-DSC system TAS-100 (manufactured by Rigaku Corporation) is used: Place about 10 mg of a toner sample in a sample container made of aluminum; Place the sample container on a holder unit; Set the holder unit in an electric furnace; Heat the electric furnace from room temperature to 150° C. at a temperature rising speed of 10° C./min; Leave it at 150° C. for 10 minutes; Cool down the sample to room temperature and leave it for 10 minutes; Thereafter, heat the sample in a nitrogen atmosphere to 150° C. at a temperature descending speed of 10° C./min; Measure the DSC curve by a differential scanning calorimeter (DSC); and, from the obtained DSC curve, calculate the glass transition temperature (Tg) from the intersection point of a tangent of the endothermic curve around the glass transition temperature (Tg) and the base line using the analysis system installed in TAS-100 system.

According to a further study of the present invention, a precursor (a polymer having a portion reactive with a compound having an active hydrogen group) is a binder resin component to have a good low temperature fixing property and a hot offset resistance property and the weight average molecular weight of the polymer is preferably from 3,000 to 20,000. That is, when the weight average molecular weight is too small, the reaction speed control tends to be difficult, which causes a problem of the manufacturing stability. When a weight average molecular weight is too large, the modified polyester tends to be insufficiently obtained, which has an impact on the offset resistance.

According to a further study on the present invention, it is found that the acid value of a toner has a large impact on the low temperature fixing property and the hot offset resistance in comparison with the acid value of a binder resin. The acid value of the toner of the present invention relates to the end carboxyl group of a non-modified polyester and the acid value of the non-modified polyester is preferably from 0.5 to 40.0 mgKOH/g to control the low temperature fixing property (e.g., lowest fixing temperature and hot offset occurrence temperature) of the toner. When the acid value of the toner is excessively large, elongation or cross-linking reaction of the modified polyester tends to be insufficient, which affects the hot offset resistance property. When the toner acid value is excessively small, the dispersion stability effect by the base compound during manufacturing is not easily obtained so that the elongation or cross-linking reaction of the modified polyester tends to proceed excessively, which causes a problem in manufacturing stability.

The acid value of the toner is measured according to JIS K0070. When a sample is not dissolved in a solvent, another solvent such as dioxane or THF is used.

The acid value is specifically determined according to the following procedure.
Measuring device: automatic potentiometric titrator (DL-53 Titrator manufactured by Mettler Toledo International Inc.)
Electrode: DG113-SC (manufactured by Mettler Toledo International Inc.)
Analysis software: LabX Light Version 1.00.000
Calibration: use a solvent mixture of 120 ml of toluene and 30 ml of ethanol
Measuring temperature: 23° C.

The measuring conditions are as follows:

Stir

| | |
|---|---|
| Speed [%] | 25 |
| Time [s] | 15 |

EQP titration
Titrant/Sensor

| | |
|---|---|
| Titrant | CH₃ONa |
| Concentration [mol/L] | 0.1 |
| Sensor | DG115 |
| Unit of measurement | mV |

Predispensing to volume

| | |
|---|---|
| Volume [mL] | 1.0 |
| Wait time [s] | 0 |

Titrant addition Dynamic

| | |
|---|---|
| dE(set) [mV] | 8.0 |
| dV(min) [mL] | 0.03 |
| dV(max) [mL] | 0.5 |

Measure mode Equilibrium controlled

| | |
|---|---|
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. termination conditions | No |

Evaluation
Procedure Standard

| | |
|---|---|
| Potential 1 | No |
| Potential 2 | No |
| Stop for reevaluation | No |

### Measuring Method of Acid Value

The acid value is measured according to the measuring method described in JIS K0070-1992.

Sample adjustment: 0.5 g of toner (the composition soluble in ethyl acetate: 0.3 g) is added to 120 ml of toluene and the mixture is stirred at room temperature (23° C.) for about 10 hours to dissolve the toner. 30 ml of ethanol is added thereto to prepare a sample solution.

The acid value can be measured by the device specified in JIS K0070-1992 and calculated as follows:

Preliminarily standardized N/10 caustic potash-alcohol solution is used for titration and the acid is calculated from the consumption amount of the caustic potash-alcohol solution using the following relationship:

Acid value=KOH (ml)×N×56.1/(weight of sample material), where N represents the factor in N/10 KOH

The glass transition temperature of the toner of the present invention preferably ranges from 40 to 70° C. to obtain a good low temperature fixing property, a good high temperature preservability, and a high durability. When the glass transition temperature is too low, blocking in a development device and filming on an image bearing member tend to occur. When the glass transition temperature is too high, the low temperature fixing property easily deteriorates. The toner of the present invention is obtained by dispersing an oil phase including a toner component and/or a precursor thereof in an aqueous medium, or dispersing or dissolving in an organic solvent at least a binder resin, a precursor thereof (a polymer having a portion reactive with a compound having an active hydrogen group), a coloring agent, a releasing agent, a complex of the binder resin and a laminar inorganic mineral having ions in which at least part of the ions are modified by an organic ion, dispersing the solution or liquid dispersion in an aqueous medium containing resin particulates to conduct reaction of the polymer having a portion reactive with a compound having an active hydrogen group and removing the organic solvent after or during the reaction followed by washing and drying.

A specific example of the precursor (polymer having a portion reactive with a compound having an active hydrogen group) is a reactive modified polyester based resin (RMPE) reactive with active hydrogen. A specific example of the polymer is a prepolymer A having an isocyanate group. A specific example of the polyester prepolymer (A) is a compound obtained by conducting reaction between a polyisocyanate (PIC) and a polyester having an active hyderogen group which is a polycondensation of the polyol (PO) and the polycarbobate (PC). Specific examples of the active hydrogen group contained in the polyester include, but are not limited to, hydroxyl groups (alcohol hydroxyl groups and phenol hydroxyl groups), amino groups, carboxylic groups, and mercarpto groups. Among these, alcohol hydroxyl groups are preferred. Amines are used as a cross-linking agent to the reactive modified polyester based resins and diisocyanate compounds (diphenylmethane diisocyanate, etc.) are used as an elongation agent. Amines, which are described in detail later, function as a cross-linking agent and/or an elongation agent for modified polyesters reactive with active hydrogen.

Modified polyesters such as urea modified polyesters obtained by reaction between the polyester prepolymer (A) having an isocyanate group and the amine (B) can be easily controlled about the molecular weight of the polymer component of the modified polyester. This is advantageous to secure the low temperature fixing property for dry toner, especially in a case in which an oil application mechanism for a heating medium is not used. A polyester prepolymer urea-modified at its end especially prevents adhesion of toner to a heating medium for fixing while not damaging the high fluidity and transparency of a non-modified polyester resin in the fixing temperature range.

Polyester prepolymers preferably for use in the present invention are obtained by introducing a functional group such as an isocyanate group reactive with an active hydrogen to a polyester having an active hydrogen group such as an acid group or a hydroxyl group at its end. Modified polyesters (MPE) such as a urea-modified polyester can be produced from this polyester prepolymer. In the present invention, the urea-modified polyesters preferably used as the toner binder are obtained by conducting reaction of the polyester prepolymer (A) having an isocyanate group with the amine (B) functioning as a cross-linking agent and/or an elongation agent. The polyester prepolymer (A) having an isocyanate group can be obtained by reacting a polyisocyanate (PIC) with a polyester having an active hyderogen group which is a polycondensation of the polyol (PO) and the polycarbobate (PC). Specific examples of the active hydrogen group contained in the polyesters mentioned above include, but are not limited to, hydroxyl groups (alcohol hydroxyl groups and phenol hydroxyl groups), amino groups, carboxylic groups, and mercarpto groups. Among these, alcohol hydroxyl groups are preferred.

Suitable polyols (P0) include diols (DIO) and polyols (TO) having three or more hydroxyl groups. It is preferred to use a diol (DIO) alone or mixtures in which a small amount of a polyol (TO) is mixed with a diol (DIO).

Specific examples of the diols (DIO) include, but are not limited to, alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the alicyclic diols mentioned above with an alkylene oxide (e.g., ethylene oxide, propylene oxide and butylene oxide); and adducts of the bisphenols mentioned above with an alkylene oxide (e.g., ethylene oxide, propylene oxide and butylene oxide); etc.

Among these compounds, alkylene glycols having from 2 to 12 carbon atoms and adducts of a bisphenol with an alkylene oxide are preferable. More preferably, adducts of a bisphenol with an alkylene oxide, or mixtures of an adduct of a bisphenol with an alkylene oxide and an alkylene glycol having from 2 to 12 carbon atoms are used.

Specific examples of the polyols (TO) include, but are not limited to, aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc.

Suitable polycarboxylic acids (PC) include dicarboxylic acids (DIC) and polycarboxylic acids (TC) having three or more carboxyl groups. It is preferred to use dicarboxylic acids (DIC) alone or mixtures in which a small amount of a polycarboxylic acid (TC) is mixed with a dicarboxylic acid (DIC).

Specific examples of the dicarboxylic acids (DIC) include, but are not limited to, alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acids (TC) having three or more hydroxyl groups include, but are not limited to, aromatic polycarboxylic acids having from 9 to 20 carbon atoms (e.g., trimellitic acid and pyromellitic acid).

As the polycarboxylic acid (TC), anhydrides or lower alkyl esters (e.g., methyl esters, ethyl esters or isopropyl esters) of the polycarboxylic acids specified above can be used for the reaction with a polyol.

Suitable mixing ratio (i.e., an equivalence ratio [OH]/[COOH]) of a polyol (PO) to a polycarboxylic acid (PC) is from 2/1 to 1/1, preferably from 1.5/1 to 1/1 and more preferably from 1.3/1 to 1.02/1.

Specific examples of the polyisocyanates (PIC) include, but are not limited to, aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic didicosycantes (e.g., tolylene diisocyanate and diphenylmethane diisocyanate); aromatic aliphatic diisocyanates (e.g., α, α, α′, α′-tetramethyl xylylene diisocyanate); isocyanurates; blocked polyisocyanates in which the polyisocyanates mentioned above are blocked with phenol derivatives, oximes or caprolactams; etc. These compounds can be used alone or in combination.

When a polyester prepolymer (A) having an isocyanate group is obtained, a suitable mixing ratio (i.e., [NCO]/[OH]) of a polyisocyanate (PIC) to a polyester having a hydroxyl group is from 5/1 to 1/1, preferably from 4/1 to 1.2/1 and more preferably from2.5/1 to 1.5/1. When the [NCO]/[OH] ratio is too large, the low temperature fixability of the toner easily deteriorates. When the [NCO]/[OH] ratio is too small, the content of the urea in the ester decreases when a modified polyester is used, which leads to deterioration of hot offset resistance. The content of the constitutional component of a polyisocyanate (PIC) in the polyester prepolymer (A) having a polyisocyanate group at its end portion is from 0.5 to 40% by weight, preferably from 1 to 30% by weight and more preferably from 2 to 20% by weight. A content that is too small tends to degrade the hot offset resistance and is disadvantageous in terms of the combination of the hot offset preservability and the low temperature fixing property. A content that is too large tends to degrade the low temperature fixing property.

The number of isocyanate groups included in the prepolymer (A) per molecule is normally not less than 1, preferably from 1.5 to 3, and more preferably from 1.8 to 2.5. When the number of isocyanate groups is too small, the molecular weight of the urea-modified polyester tends to be small, which degrades the hot offset resistance.

Specific examples of the amine (B) include, but are not limited to, diamines (B1), polyamines (B2) having three or more amino groups, amino alcohols (B3), amino mercaptans (B4), amino acids (B5), and blocked amines (B6), in which the amines (B1-B5) mentioned above are blocked.

Specific examples of the diamines (B1) include, but are not limited to, aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific examples of the polyamines (B2) having three or more amino groups include, but are not limited to, diethylene triamine, triethylene and tetramine. Specific examples of the amino alcohols (B3) include, but are not limited to, ethanol amine and hydroxyethyl aniline. Specific examples of the amino mercaptan (B4) include, but are not limited to, aminoethyl mercaptan and aminopropyl mercaptan. Specific examples of the amino acids (B5) include, but are not limited to, amino propionic acid and amino caproic acid. Specific examples of the blocked amines (B6) include, but are not limited to, ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine (B1) is mixed with a small amount of a polyamine (B2) are preferable.

Furthermore, the molecular weight of the polyesters can be controlled when a prepolymer (A) and an amine (B) are reacted, if desired. Specific examples of such molecular weight control agents include, but are not limited to, monoamines (e.g., diethyl amine, dibutyl amine, butyl amine and lauryl amine) having no active hydrogen group, and blocked amines (i.e., ketimine compounds) prepared by blocking the monoamines specified above.

The mixing ratio of the amines (B) to the prepolymer (A), i.e., the equivalent ratio ([NCO]/[NHx]) of the isocyanate group [NCO] contained in the prepolymer (A) to the amino group [NHx] contained in the amines (B), is normally from 1/2 to 2/1, preferably from 1.5/1 to 1/1.5 and more preferably from 1.2/1 to 1/1.2. When the mixing ratio is too large or too small, the molecular weight of the resultant polyester decreases, resulting in deterioration of the hot offset resistance of the resultant toner.

In the present invention, the polyester based resins (polyester) preferably used as the binder resin are urea-modified polyesters (UMPE). These urea-modified polyesters (UMPE) can include a urethane linkage as well as a urea linkage. The molar ratio of the content of the urea linkage to the content of the urethane linkage may vary from 100/0 to 10/90, preferably from 80/20 to 20/80 and more preferably from 60/40 to 30/70. When the content of the urea linkage is too low, the hot offset resistance of the resultant toner tends to deteriorate.

The urea-modified polyesters (UMPE) of the present invention can be prepared in different ways, including, for example, one-shot methods. The weight average molecular weight of the urea-modified polyesters (UMPE) is not less than 10,000, preferably from 20,000 to 10,000,000 and more preferably from 30,000 to 1,000,000. When the weight average molecular weight is too small, the hot offset resistance property easily deteriorates. The number average molecular weight of the urea-modified polyesters is not particularly limited when the unmodified polyester (PE) described below is used in combination. Namely, controlling of the weight average molecular weight of the modified polyester resins has priority over controlling of the number average molecular weight thereof. However, when a urea-modified polyester (UMPE) is used alone, the number average molecular weight thereof ranges from 2,000 to 15,000, preferably from 2,000 to 10,000 and more preferably from 2,000 to 8,000. When the number average molecular weight is too large, the low temperature fixability of the resultant toner tends to deteriorate, and in addition the gloss of full color images deteriorates when the toner is used in a full color image forming apparatus.

In the present invention, the modified polyester such as the urea-modified polyester (UMPE) can be used in combination with an unmodified polyester (PE) contained as the binder resin component. By using a combination of a urea-modified polyester (UMPE) with an unmodified polyester (PE), the low temperature fixability of the toner improves and in addition the toner can produce color images having high gloss when the toner is used in a full-color image forming apparatus. The combinational use is preferred to a single use of the modified polyester. Specific examples of the polyester (PE) include, but are not limited to, polycondensation products of the polyol (PO) and the polycalboxylic acid (PC) specified for the polyester component of the urea-modified polyester (UMPE) and preferred examples thereof are the same as those for the urea-modified polyester (UMPE). The weight average molecular weight (Mw) of the polyester (PE) ranges from 10,000 to 300,000 and preferably from 14,000 to 200,000. The number average molecular weight (Mn) of the polyester (PE) ranges from 1,000 to 10,000 and preferably from 1,500 to 6,000. In addition to the non-modified polyester, modified polyesters modified by a chemical linkage other than urea linkage, for example, urethane linkage, can be used in combination with the urea-modified polyester (UMPE). The urea-modified polyester (UMPE) and the non-modified polyester (PE) are preferred to be at least partially compatible with each other to improve the low temperature fixability and hot offset resistance properties. Therefore, it is preferable, but not mandatory, that the polyester component in the urea-modified polyester (UMPE) has a similar composition to that of the non-modified polyester (PE). The weight ratio of the urea-modified polyester/the non-modified polyester is normally from 5/95 to 80/20, preferably from 5/95 to 30/70, more preferably from 5/95 to 25/75 and even more preferably from 7/93 to 20/80. A content of the urea-modified polyester (UMPE) that is too small tends to degrade the hot offset resistance of the toner and in addition be disadvantageous in terms of a good combination of the high temperature preservability and low temperature fixability.

The hydroxyl value (mgKOH/g) of the unmodified polyester (PE) is preferably 5 or higher. The acid value (mgKOH/g) of the unmodified polyester (PE) is from 1 to 30 and more preferably from 5 to 20. When a polyester having such an acid value is used, the produced toner is easily negatively charged and the affinity of the toner to a recording medium is improved when a toner image on the recording medium is fixed. However, an acid value that is excessively high has an adverse impact on the stability of chargeability and especially on the anti-environment change. In the polymerization reaction, a variance of the acid value leads to a variance in the granulation process, meaning that controlling emulsification is difficult.

The hydroxyl value and the acid value of the unmodified polyester (PE) are specifically determined according to the following procedure.
Measuring device: automatic potentiometric titrator (DL-53 Titrator manufactured by Mettler Toledo International Inc.)
Electrode: DG113-SC (manufactured by Mettler Toledo International Inc.)
Analysis software: LabX Light Version 1.00.000
Calibration of device: use a solvent mixture of 120 ml of toluene and 30 ml of ethanol
Measuring temperature: 23° C.

The measuring conditions are as follows:

Stir

| | |
|---|---|
| Speed [%] | 25 |
| Time [s] | 15 |

EQP titration
Titrant/Sensor

| | |
|---|---|
| Titrant | CH₃ONa |
| Concentration [mol/L] | 0.1 |
| Sensor | DG115 |
| Unit of measurement | mV |

Predispensing to volume

| | |
|---|---|
| Volume [mL] | 1.0 |
| Wait time [s] | 0 |

Titrant addition Dynamic

| | |
|---|---|
| dE(set) [mV] | 8.0 |
| dV(min) [mL] | 0.03 |
| dV(max) [mL] | 0.5 |

Measure mode Equilibrium controlled

| | |
|---|---|
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. termination conditions | No |

Evaluation
Procedure Standard

| | |
|---|---|
| Potential 1 | No |
| Potential 2 | No |
| Stop for reevaluation | No |

### Method of Measuring Acid Value

The acid value is measured according to the measuring method described in JIS K0070-1992.

Sample adjustment: 0.5 g of toner (the composition soluble in ethyl acetate: 0.3 g) is added to 120 ml of toluene and the mixture is stirred at room temperature (23° C.) for about 10 hours to dissolve the polyester. 30 ml of ethanol is added thereto to prepare a sample solution.

The acid value can be measured by the device described in JIS K0070-1992 and calculated specifically as follows:

Preliminarily standardized N/10 caustic potash-alcohol solution is used for titration and the acid is calculated from the consumption amount of the caustic potash-alcohol solution using the following relationship:

Acid value=KOH (ml)×N×56.1/(weight of sample material), where N represents the factor in N/10 KOH

### Measuring Method of Hydroxyl Value

Precisely weigh 0.5 g of a sample in a 100 ml flask; correctly add 5 ml to acetylation reagent thereto; heat the system by placing in a bath in the temperature range of from 95 to 105° C.; after one to two hours, remove the flask from the bath; subsequent to cooling down and addition of water, decompose acetic anhydride by shaking the flask; heat the flask in the bath again for at least 10 minutes to complete the decomposition; subsequent to cooling down, steadily wash the wall of the flask with an organic solvent; conduct potentiometric titration of the liquid using a solution of N/2 potassium hydroxide ethyl alcohol with the electrode specified above to obtain the hydroxyl value (according to JIS K0070-1966).

In the present invention, the binder resin has a glass transition temperature (Tg) of from 40 to 70° C., and preferably from 40 to 60° C. When the glass transition temperature is too low, the high temperature preservability of the toner tends to deteriorate. In contrast, when the glass transition temperature is too high, the low temperature fixing property easily deteriorates. Since an unmodified polyester such as a urea-modified polyester coexists in the binder resin, the glass transition temperature of the toner has a good high temperature preservability even when the glass transition temperature is relatively low in comparison with that of a known polyester based toner.

### Modified Laminar Inorganic Mineral

The modified laminar inorganic mineral for use in the toner of the present invention is preferably obtained by modifying a laminate inorganic mineral having a basic crystal structure of a smectite with an organic cation. Specific examples of the laminate inorganic minerals include, but are not limited to, monmolinite, bentonite, beidellite, nontronite, saponite and hectorite.

Specific examples of organic ion modification agents for modifying the laminar inorganic mineral include, but are not limited to, quaternary alkyl ammonium salts, phosphonium salts and imidazolium salts. Among these, quaternary alkyl ammonium salts are preferred. Specific examples of the quaternary alkyl ammonium salts include, but are not limited to, trimethyl stearyl ammonium, dimethyl stearyl benzyl ammonium, diemthyl octadecyl ammonium, and oleylbis(2-hydroxyethyl)methylammonium.

Specific examples of the modified laminar inorganic minerals include, but are not limited to, BENTONE 34, BENTONE 52, BENTONE 38, BENTONE 27, BENTONE 57, BENTONE SD1, BENTONE SD2 and BENTONE SD3 (manufactured by Elementis, plc.), CRAYTONE 34, CRAYTONE 40, CRAYTONE HT, CRAYTONE 2000, CRAYTONE AF, CRAYTONE APA and CRAYTONE HY (manufactured by Southern Clay Products, Inc.), ESBEN, ESBEN E, ESBEN C, ESBEN NZ, ESBEN NZ70, ESBEN W, ESBEN N400, ESBEN NX, ESBEN NX 80, ESBEN NO12S, ESBEN NEZ, ESBEN NO12, ESBEN WX, ESBEN NE, etc. (manufactured by Hojun Co., Ltd.), and KUNIBIS 110, KUNIBIS 120, KUNIBIS 127, etc.(manufactured by Kunimine Industries Co., Ltd.).

The complex of the modified laminar inorganic mineral and a binder resin, i.e., master batch, is typically prepared by mixing and kneading the binder resin and a laminar inorganic mineral modified by an organic cation upon application of high shear stress thereto. An organic solvent can be used to boost the interaction of the modified laminar inorganic mineral with the binder resin. In addition, flushing methods in which an aqueous paste including the modified laminar inorganic mineral and water is mixed and kneaded with a resin solution of an organic solvent to transfer the modified laminar inorganic mineral to the resin solution and then the aqueous liquid and organic solvent are removed can be preferably used because the resultant wet cake of the modified laminar inorganic mineral can be used as it is, i.e., dispensing with drying. A high shear dispersion device such as a three-roll mill is preferably used for mixing and kneading the mixture.

In the complex of the modified laminar inorganic mineral and a binder resin, i.e., master batch, the modified laminar inorganic mineral has a volume average particle diameter Dv of from 0.1 to 0.55 μm and the ratio of the modified laminar inorganic mineral having a volume average particle diameter of 1 μm or greater is 15% or lower. A volume average particle diameter Dv that is too large, or a ratio of the modified laminar inorganic mineral having a volume average particle diameter of 1 μm or greater that is too high tends to have a negative impact on the toner form or degrade the toner chargeability.

The modified laminar inorganic mineral is preferably contained in a toner in the range of from 0.1 to 5%. A ratio that is too small easily degrades the effect on the toner form and the toner chargeability or a ratio that is too large tends to have an adverse impact on the fixing property.

### Releasing Agent

As a wax (releasing agent) for use in the toner of the present invention, a wax having a low melting point (from 50 to 120° C.) effectively functions in the dispersion with a binder resin at the interface between a fixing roller and a toner. Thereby, the toner has a good hot offset resistance without applying a releasing agent such as oil to a fixing roller. The melting point of the wax for use in the present invention is the maximum endothermic peak according to the differential scanning calorimeter (DSC). The following material can be used as the wax component functioning as the releasing agent for use in the present invention.

Specific examples of such waxes include, but are not limited to, natural waxes such as plant waxes such as carnauba wax, cotton wax, haze wax, and rice wax, animal waxes such as yellow bees wax and lanoline, mineral waxes such as ozokerite and petroleum waxes such as paraffin wax, microcrystalline wax and petrolatum. Other than these natural waxes, synthetic hydrocarbon waxes such as Fisher-Tropsch wax and polyethylene wax, and synthetic waxes such as esters, ketons, and ethers can be used. Further, fatty acid amides such as 1,2-hydroxystearic acid amide, stearic acid amides, anhydrous phthalic acid imides and chlorinated hydrocarbons, homo polymers or copolymers (e.g., copolymers of n-staryl acrylate-ethylmethacrylate) of a polyacrylate, which is a crystalline polymer resin having a relatively low molecular weight, such as poly-n-stearyl methacrylate and poly-n-lauric methacrylate, and crystalline polymers having a long chain alkyl group on its branched chain can be also used.

### Coloring Agent

There is no specific limit to the coloring agents for use in the toner. Specific examples thereof include, but are not limited to, carbon black, Nigrosine dyes, black iron oxide, Naphthol Yellow S, HANSA Yellow (10G, 5G and G), Cadmium Yellow, yellow iron oxide, loess, chrome yellow, Titan Yellow, polyazo yellow, Oil Yellow, HANSA Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, LITHOL Fast Scarlet G, Brilliant Fast Scarlet, Brilliant Carmine BS, Permanent Red (F2R, F4R, FRL, FRLL and F4RH), Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, PYRAZOLONE Red, polyazo red, Chrome Vermilion, Benzidine Orange, perynone orange, Oil Orange, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B. Green Gold, Acid Green Lake, Malachite Green Lake, Phthalocyanine Green, Anthraquinone Green, titanium oxide, zinc oxide, lithopone and a mixture thereof. The content of such a coloring agent is from 1 to 15% by weight and preferably from 3 to 10% by weight based on the content of toner.

Master batch pigments, which are prepared by combining a coloring agent with a binder resin, can be used as the coloring agent of the toner composition of the present invention.

Specific examples of the binder resins for use in the master batch pigments or for use in combination with master batch pigments include, but are not limited to, the modified polyester resins and the unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins can be used alone or in combination.

An organic solvent in which a polyester, for example, a urea-modified polyester and a prepolymer (A), is soluble can be used to decrease the viscosity of a medium dispersion containing a toner component. Using such a solvent is preferable because the particle size distribution can be sharp. The organic solvent is preferred to be volatile and have a boiling point lower than 100° since it is easy to remove such an organic solvent.

Specific examples thereof include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone and methylisobutyl ketone. These can be used alone or in combination. Especially, aromatic series based solvent, for example, toluene and xylene, and halogenated hydrocarbons, for example, methylene chloride, 1,2-dichloroethane, chloroform and carbon tetrachloride, are preferred.

The content of the organic solvent is from 0 to 300 parts by weight, preferably from 0 to 100 parts by weight and more preferably from 25 to 70 parts by weight based on 100 parts by weight of a prepolymer (A). When such a solvent is used, the solvent is removed from the resultant product under normal pressure or a reduced pressure after the elongation and/or cross-linking reaction of a modified polyester (prepolymer) by an amine.

The master batch mentioned above is typically prepared by mixing and kneading a resin and a coloring agent upon application of high shear stress thereto. In this case, an organic solvent can be used to boost the interaction of the coloring agent with the resin. In addition, flushing methods in which an aqueous paste including a coloring agent is mixed with a resin solution of an organic solvent to transfer the coloring agent to the resin solution and then the aqueous liquid and organic solvent are removed can be preferably used because the resultant wet cake of the coloring agent can be used as it is, i.e., dispensing with drying. In this case, a high shear dispersion device such as a three-roll mill is preferably used for mixing and kneading the mixture.

A method of manufacturing toner is known in which particles containing a coloring agent and a resin and particles formed of at least a charge control agent are mixed by a rotor in a container to attach and fix a charge control agent to the surface of toner particles. In the present invention, target toner particles are obtained in this method including a mixing process in which the particles are mixed in the container without having a fixing member extruding from the inner wall of the container at a circumferential speed of the rotor ranging from 40 to 150 m/sec.

The toner is described next.

The toner of the present invention optionally includes a charge control agent. Any known charge controlling agent can be used. Specific examples thereof include, but are not limited to, nigrosine dyes, triphenylmethane dyes, chrome containing metal complex dyes, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, metal salts of salicylic acid derivatives, etc. Specific examples thereof include, but are not limited to, BONTRON 03 (nigrosine dye), BONTRON P-51 (quaternary ammonium salt), BONTRON S-34 (metal containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE PR (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group, for example, sulfonic acid group, carboxyl group, quaternary ammonium group, etc.

The content of the charge control agent is determined depending on the kind of the binder resin used, whether or not an additive is added, and the toner manufacturing method including the dispersion method. Therefore, it is not easy to jump to any conclusion but the content of the charge control agent is preferably from 0.1 to 10 parts by weight, and more preferably from 0.2 to 5 parts by weight based on 100 parts by weight of the binder resin included in the toner. When the content is too large, the toner tends to have too large chargeability, which leads to reduction in the effect of a main charge control agent, and thereby the electrostatic force with a developing roller increases, resulting in deterioration of the fluidity of the toner and a decrease in the image density of toner images. These charge control agents and releasing agents can be melted, mixed and kneaded with a master batch and a binder resin or added when dissolved or dispersed in an organic solvent.

An external additive can be added to the toner of the present invention to help improving the fluidity, developability, chargeability of coloring agents. Inorganic particulates are suitably used as such an external additive. It is preferred for the inorganic particulate to have a primary particle diameter of from 5 nm to 2 μm, and more preferably from 5 nm to 500 nm. In addition, it is preferred that the specific surface area of such inorganic particulates measured by the BET method is from 20 to 500 m²/g. The content of such an inorganic particulate is preferably from 0.01 to 5% by weight and particularly preferably from 0.01 to 2.0% by weight based on the weight of a toner.

Specific examples of such inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

As a fluidity agent, it is preferred to use hydrophobic silica particulates and hydrophobic titanium oxide particulates in combination. Especially when stirring and mixing are performed using such particulates having an average particle diameter of not greater than 50 nm, the electrostatic force and van der Waals force with a toner are extremely ameliorated. Therefore, during stirring and mixing in the development device performed for obtaining a desired level of charging, a fluidity agent is not detached from a toner particle so that quality images can be obtained free of the formation of non-image transferred spots in the form of the glow of fireflies in the dark and the amount of toner remaining on an image bearing member after transfer is reduced.

Titanium oxide particulates are excellent in terms of environmental stability and image density stability but has a problem with charge rising characteristics. Therefore, when the addition amount of titanium oxide particulates is greater than the addition amount of silica particulates, the side effect of containing titanium oxide particulates may have a large impact. However, when the addition amount of hydrophobic silica particulates and hydrophobic titanium oxide particulates ranges from 0.3 to 1.5% by weight, desirable charge rise characteristics are obtained, i.e., the charge rise characteristics do not greatly deteriorate. That is, when photocopying is repeated, the quality of obtained images is stable and scattering of toner particles from the development device can be effectively prevented.

The binder resin for toner can be manufactured by the following methods, etc. Polyol (PO) and Polycarboxylic acid (PC) are heated under the presence of a known esterification catalyst such as tetrabuthoxy titanate and dibutyltin oxide to a temperature of from 150 to 280° C. with a reduced pressure, if desired, while removing produced water to obtain a polyester having a hydroxyl group. Then, polyisocyanate (PLIC) is reacted with the polyester in the temperature range of from 40 to 140° C. to obtain polyester prepolymer (A) having an isocyanate group. The polyester prepolymer (A) is reacted with amine (B) at the temperature range of from 0 to 140° C. to obtain a urea-modified polyester (UMPE). The modified polyester has a number average molecular weight of from 1,000 to 10,000 and preferably from 1,500 to 6,000. When the polyisocyanate (PIC) is reacted or the polyester prepolymer (A) and the amine (B) are reacted, a solvent can be used, if desired. Specific examples thereof include, but are not limited to, aromatic solvents (e.g., toluene and xylene), ketones (e.g., acetone, methylethyl ketone and methylisobutyl ketone), esters (e.g., ethyl acetate), amides (e.g., dimethylformamide and dimethylacetamide), and ethers (e.g., tetrahydrofuran), which are inactive with a polyisocyanate (PIC). When polyester (PE) not modified with a urea-linkage is used in combination, this polyester (PE) is prepared by the same method as the method f or a polyester having a hydroxyl group and is dissolved and mixed in the solution of the urea-modified polyester obtained after the reaction is complete.

The toner of the present invention can be manufactured by the following method but the method of manufacturing the toner is not limited thereto.

### Method of Manufacturing Toner in Aqueous Medium

Suitable aqueous media for use in the present invention include water, and mixtures of water with a solvent which can be mixed with water. Specific examples of such a solvent include, but are not limited to, alcohols (e.g., methanol, isopropanol and ethylene glycol), dimethylformamide, tetrahydrofuran, cellosolves (e.g., methyl cellosolve), lower ketones (e.g., acetone and methyl ethyl ketone), etc.

In the present invention, a urea-modified polyester (UMPE) can be obtained by conducting a reaction between a reactive modified polyester such as a polyester prepolymer (A) having an isocyanate group and an amine (B) in an aqueous medium. As a method of stably forming a dispersion body formed of a reactive modified polyester and a prepolymer (A) such as a urea-modified polyester in an aqueous medium, there is a method in which a composition of a toner material formed of a reactive modified polyester and a prepolymer (A) such as a urea-modified polyester is added to an aqueous medium followed by dispersion using a shearing force.

A reactive modified polyester such as prepolymer (A) and other toner composition such as a coloring agent, a coloring agent master batch, a releasing agent and a non-modified polyester resin can be mixed in an aqueous medium when a dispersion body is formed. However, it is preferred that the toner compositions are preliminarily mixed and then the mixture is added to and dispersed in an aqueous medium. Also, in the present invention, the other toner compositions such as a coloring agent, a releasing agent and a charge control agent are not necessarily mixed when particles are granulated in an aqueous medium. For example, the other components can be added by a known dying method after particles are granulated without a coloring agent.

The dispersion method is not particularly limited. Specific examples thereof include, but are not limited to, low speed shearing methods, high speed shearing methods, friction methods, high pressure jet methods, ultrasonic methods, etc. Among these methods, high speed shearing methods are preferable because particles having a particle diameter of from 2 to 20 μm can be easily prepared. At this point, the particle diameter (2 to 20 μm) means a particle diameter of particles including a liquid.

When a high speed shearing type dispersion machine is used, the rotation speed is not particularly limited, but the rotation speed is typically from 1,000 to 30,000 rpm, and preferably from 5,000 to 20,000 rpm. The dispersion time is not particularly limited, but is typically from 0.1 to 5 minutes. The temperature in the dispersion process is typically from 0 to 150° C. (under pressure), and preferably from 40 to 98° C. When the temperature is preferably high, the viscosity formed of a urea-modified polyester or a prepolymer (A) is low, which is advantageous for easy dispersion.

The amount of an aqueous medium is normally from 50 to 2,000 parts by weight and preferably from 100 to 1,000 parts by weight based on 100 parts by weight of a toner composition containing a polyester such as a urea modified polyester and a prepolymer (A). When the amount of an aqueous medium is too small, the dispersion stability of a toner composition is degraded so that toner particles having a desired particle diameter are not obtained. An amount of an aqueous medium that is excessively large is not preferred in light of economy. A dispersion agent can be used, if desired. It is preferred to use a dispersion agent in terms that the particle size distribution is sharp and the dispersion is stable.

Various kinds of dispersion agents are used for emulsification and dispersion of an oil phase in an aqueous phase.

Specific examples of such a dispersion agent include, but are not limited to a surface active agent, an inorganic particulate dispersion agent, a polymer particulate dispersion agent, etc.

Specific examples of the surface active agents include, but are not limited to, anionic dispersion agents, for example, alkylbenzene sulfonic acid salts, α-olefin sulfonic acid salts, and phosphoric acid salts; cationic dispersion agents, for example, amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic dispersion agents, for example, fatty acid amide derivatives, polyhydric alcohol derivatives; and ampholytic dispersion agents, for example, alanine, dodecyldi(aminoethyl)glycin, di(octylaminoethyle)glycin, and N-alkyl-N,N-dimethylammonium betaine.

Using a surface active agent having a fluoroalkyl group in an extremely small amount is effective for good dispersion. Preferred specific examples of the anionic surface active agents having a fluoroalkyl group include, but are not limited to, fluoroalkyl carboxylic acids having from 2 to 10 carbon atoms and their metal salts, disodium perfluorooctane sulfonyl glutamate, sodium 3-{omega-fluoroalkyl(C6-C11)oxy}-1-alkyl(C3-C4)sulfonate, sodium 3-{omega-fluoroalkanoyl(C6-C8)-N-ethylamino}-1-propanesulfonate, fluoroalkyl(C11-C20)carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such anionic surface active agents having a fluoroalkyl group include, but are not limited to, SURFLON® S-111, S-112 and S-113, which are manufactured by Asahi Glass Co., Ltd.; FRORARD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP® EF-102, 103, 104, 105, 112, 123A, 306A, 501, 201 and 204, which are manufactured by Tohchem Products Co., Ltd.; FUTARGENT® F-100 and F150 manufactured by Neos; etc.

Specific examples of the cationic surface active agents having a fluoroalkyl group include, but are not limited to, primary or secondary aliphatic or secondary amino acids, aliphatic quaternary ammonium salts (for example, perfluoroalkyl(C6-C10)sulfoneamidepropyltrimethyl ammonium salts), benzalkonium salts, benzetonium chloride, pyridinium salts, and imidazolinium salts.

Specific examples of the marketed products of such catiotic surface active agents having a fluoroalkyl group include, but are not limited to, SURFLON® S-121 (from Asahi Glass Co., Ltd.); FRORARD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP® EF-132 (from Tohchem Products Co., Ltd.); FUTARGENT® F-300 (from Neos); etc.

In addition, a water hardly soluble inorganic dispersing agents can be used. Specific examples thereof include, but are not limited to, tricalcium phosphate, calcium carbonate, titanium oxide, colloidal silica and hydroxyapatite.

Particulate polymers have been confirmed to have the same effect as an inorganic dispersion agent.

Specific examples of the particulate polymers include, but are not limited to, particulate polymethyl methacylate (MMA) having a particle diameter of 1 and 3 μm, particulate polystyrene having a particle diameter of 0.5 and 2 μm, particulate styrene-acrylonitrile copolymers having a particle diameter of 1 μm, etc. Specific examples of the marketed particulate polymers include, but are not limited to, PB-200H (available from Kao Corp.), SGP (available from Soken Chemical & Engineering Co., Ltd.), TECHNOPOLYMER® SB (available from Sekisui Plastics Co., Ltd.), SPG-3G (available from Soken Chemical & Engineering Co., Ltd.), MICROPEARL® (available from Sekisui Fine Chemical Co., Ltd.), etc.

Furthermore, toner components can be stably dispersed in an aqueous medium by using a polymeric protection colloid in combinational use with the inorganic dispersing agents and particulate polymers mentioned above. Specific examples of such polymeric protection colloids include, but are not limited to, polymers and copolymers prepared using monomers, for example, acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g., acrylamide, methacrylamide and diacetoneacrylamide) and their methylol compounds, acid chlorides (e.g., acrylic acid chloride and methacrylic acid chloride), and homopolymers or copolymers having a nitrogen atom or an alicyclic ring having a nitrogen atom (e.g., vinyl pyridine, vinyl pyrrolidone, vinyl imidazole and ethylene imine).

In addition, polymers, for example, polyoxyethylene based compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters), and cellulose compounds, for example, methyl cellulose, hydroxyethyl cellulose and hydroxypropyl cellulose, can also be used as the polymeric protective colloid.

The cross-linking time and/or the elongation time is determined depending on the reactivity determined by the combination of the structure of the isocyanate group in a prepolymer (A) and an amine (B). The cross-linking time and/or the elongation time is in general from 10 minutes to 40 hours, and preferably from 2 to 24 hours. The reaction temperature is generally from 0 to 150° C., and preferably from 40 to 98° C. In addition, a known catalyst can be optionally used. Specific examples of such elongation agents and/or cross-linking agents include, but are not limited to, dibutyltin laurate and dioctyltin laurate. Specific examples of such an elongation agent and/or a cross-linking agent include, but are not limited to, the amines (B) mentioned above.

The toner of the present invention can be mixed with a magnetic carrier to be used as a two-component developing agent. The density of the toner to the carrier is preferably from 1 to 10% by weight.

Suitable magnetic carriers for use in a two component developer include, but are not limited to, known carrier materials such as iron powders, ferrite powders, magnetite powders, and magnetic resin carriers, which have a particle diameter of from about 20 to about 200 μm. The surface of the carriers may be coated by a resin.

It is preferred to coat the surface of the carriers with a resin layer. Specific examples of such resins include, but are not limited to, amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethylene terephthalate resins and polybutylene terephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins.

If desired, an electroconductive powder can be contained in the toner. Specific examples of such electroconductive powders include, but are not limited to, metal powders, carbon blacks, titanium oxide, tin oxide, and zinc oxide. The average particle diameter of such electroconductive powders is preferably not greater than 1 μm. When the particle diameter is too large, controlling the resistance of the resultant toner tends to be difficult.

The toner of the present invention can also be used as a one-component magnetic developer or a one-component non-magnetic developer.

The image formation method of the present invention is a method in which the toner of the present invention is used in a typical image formation method using toner.

The image forming apparatus of the present invention is an image forming apparatus in which the toner of the present invention is used in a typical image forming apparatus using toner.

The image forming apparatus of the present invention using the toner of the present invention is described with reference to drawings.

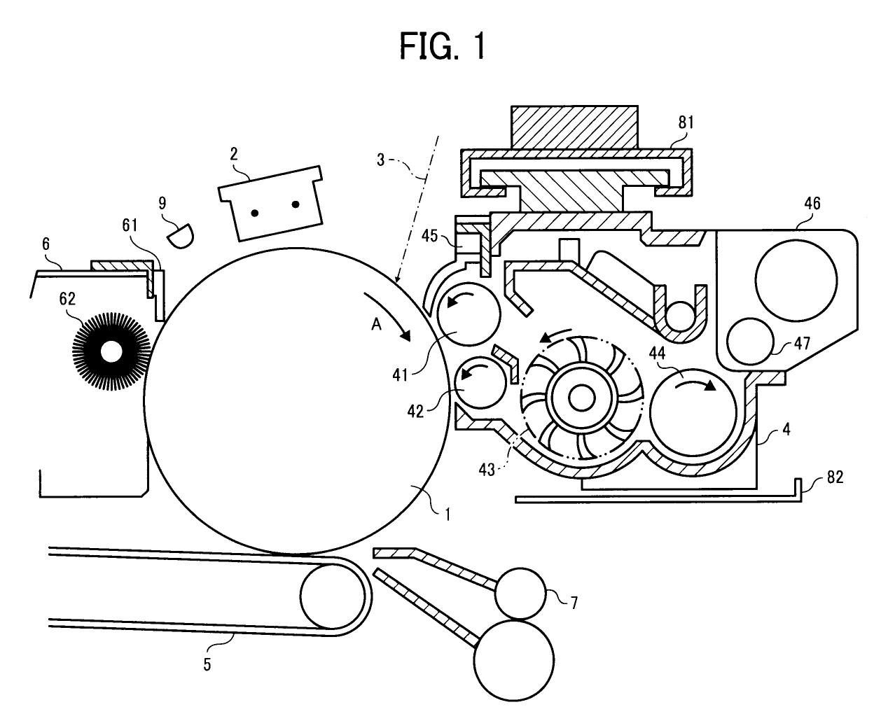

FIG. 1 is a cross-section illustrating an example of the main portion of the image forming apparatus of the present invention. In this example, the image forming apparatus is an electrophotographic photocopier. In FIG. 1, 1 represents a photoreceptor drum as a latent electrostatic image bearing member which rotates in the direction indicated by an arrow. A charging device 2 is provided around the photoreceptor drum 1. An irradiation device (not shown) irradiates the photoreceptor drum 1 with a laser beam 3 corresponding to data information obtained by scanning an original. Furthermore, a development device 4, a paper feeding device 7, a transfer device 5, a cleaning device 6, and a discharging lamp 9 are arranged around the photoreceptor drum 1. The development device 4 includes development rollers 41 and 42, a paddle form stirrer 43, a stirring member 44, a doctor blade 45, a toner supply portion 46 and a supply roller 47. The cleaning device 6 has a cleaning brush 62 and a cleaning blade 61. Members 81 and 82 situated on the top and the bottom of the development device 4 are guide rails for attachment, detachment and support of the development device 4. Working life of the cleaning blade 61 in the cleaning device 6 can be detected. The cleaning blade 61 is constantly in contact with the photoreceptor drum 1 during image formation and is abraded as the photoreceptor drum 1 rotates. When the cleaning blade 61 is abraded, the capability of the cleaning blade 61 to remove residual toner on the photoreceptor drum 1 tends to deteriorate, resulting in degradation of the quality of produced images. In addition, even when the photoreceptor drum 1 is not abraded, a cleaning problem of toner slipping through the cleaning blade 61 tends to occur when toner has a form close to a true spherical form, which improves the fluidity in comparison with a pulverization toner and contributes to improvement of the transfer property. This problem is ascribable to a polymerization toner but solved by the toner of the present invention.

The toner of the present invention is accommodated in the development container of a process cartridge, which is detachably attachable to an image forming apparatus.

The process cartridge is formed of at least a latent electrostatic image bearing member to bear a latent electrostatic image and a development device to develop the latent electrostatic image with a developing agent to form a visualized image with optional devices such as a charging device, an irradiation device, a development device, a transfer device, a cleaning device, a discharging device, etc. The development device mentioned above includes at least a developing agent container to accommodate the toner of the present invention or a developing agent containing the toner and a latent electrostatic image bearing member to bear and transfer the toner or the developing agent accommodated in the developing agent container. The development device may optionally have other devices such as a layer thickness applicator to regulate the layer thickness of the toner borne on the latent electrostatic image bearing member.

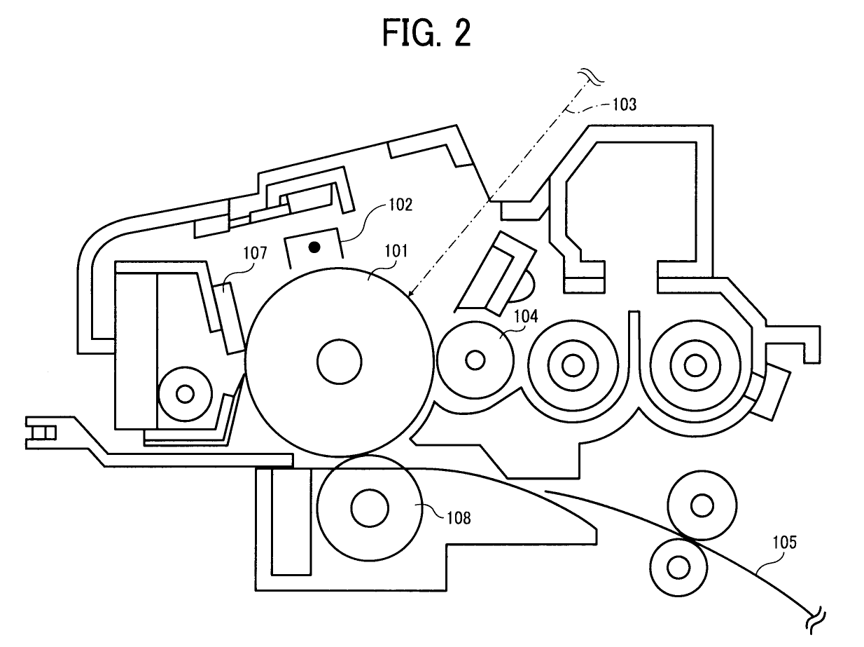

The process cartridge described above includes a photoreceptor 101, a charging device 102, a development device 104, a cleaning device 107 and other optional devices as illustrated in FIG. 2. In the example illustrated in FIG. 2, the process cartridge includes a transfer device 108 to transfer a toner image developed on the photoreceptor 101 to a recording medium 105.

The photoreceptors and image bearing members described above can be used as the photoreceptor 101.

A light source which writes a latent electrostatic image on the photoreceptor 101 with a high definition can be used as the irradiation device 103.

Any charging device can be used as the charging device 102.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present invention is described with reference to Examples but is not limited thereto.

### Manufacturing Example 1

### Manufacturing of Liquid Dispersion of Resin Particulate

The following components are placed in a container equipped with a stirrer and a thermometer and agitated at 400 rpm for 15 minutes to obtain a white emulsion.

| | |
|---|---|
| Water | 683 parts |
| Sodium salt of sulfate of an adduct | 11 parts |
| of methacrylic acid with ethyleneoxide | |
| (EREMINOR RS-30 from Sanyo | |
| Chemical Industries Ltd.) | |
| Styrene | 83 parts |
| Methacrylic acid | 83 parts |
| Butylacrylate | 110 parts |
| Ammonium persulfate | 1 part |

Thereafter, the emulsion is heated to 75° C. to conduct a reaction for 5 hours. Then, 30 parts of a 1 weight % aqueous solution of ammonium persulfate are added to the emulsion and the mixture is further aged at 75° C. for 5 hours to prepare an aqueous liquid dispersion [resin particulate liquid dispersion 1] of a vinyl based resin (copolymer of styrene-methacrylic acid-butyl acrylate-sodium salt of sulfate of an adduct of methacrylic acid with ethyleneoxide). The volume average particle diameter of [resin particulate liquid dispersion 1] measured by LA-920 is 105 nm. [resin particulate liquid dispersion 1] is partially dried to isolate the resin portion. The glass transition temperature (Tg) of the resin portion is 59° C. and the weight average molecular weight is 150,000.

### Manufacturing of Low Molecular Weight Polyester 1

The following components are placed in a reaction container equipped with a condenser, stirrer and a nitrogen introducing tube to conduct a reaction at 230° C. for 5 hours followed by another reaction with a reduced pressure of 10 to 15 mmHg for 5 hours:

| | |
|---|---|
| Adduct of bisphenol A with 2 mol of ethylene oxide | 229 parts |
| Adduct of bisphenol A with 3 mol of propion oxide | 529 parts |
| Terephthalic acid | 208 parts |
| Isophthalic acid | 46 parts |
| Dibutyl tin oxide | 2 parts |

44 parts of trimellitic anhydride is added in the reaction container to conduct a reaction at 180° C. under normal pressure for 2 hours to synthesize [low molecular weight polyester 1].

Portion of the obtained [low molecular weight polyester 1] soluble in tetrahydrofuran (THF) has a weight average molecular weight (Mw) of 5,200, a glass transition temperature (Tg) of 45° C. and an acid value of 20 mgKOH/g.

### Manufacturing of Prepolymer

The following components are placed in a reaction container equipped with a condenser, stirrer and a nitrogen introducing tube to conduct a condensation reaction at 210° C. for 8 hours in a nitrogen atmosphere under normal pressure followed by another reaction with a reduced pressure of 10 to 15 mmHg for 5 hours and dehydration. Subsequent to cooling down to 80° C., the resultant is reacted with 170 parts of isophorone diisocyanate in ethyl acetate for 2 hours to obtain [prepolymer 1]. The weight average molecular weight thereof is 5,000:

| | |
|---|---|
| Adduct of bisphenol A with 2 mol of | 795 parts |
| ethylene oxide | |
| Isophthalic acid | 200 parts |
| Terephthalic acid | 65 parts |
| Dibutyl tin oxide | 2 parts |

Manufacturing of Master Batch 1
The following recipe is mixed by a HENSCEL MIXER
(manufactured by Mitsui Mining Co., Ltd.)

| | |
|---|---|
| Water | 1,200 parts |
| BENTONE 57 (organic modified bentonite, | 174 parts |
| quaternary ammonium cation modification | |
| treated product, manufactured by Elementis | |
| plc.) | |
| [Low molecular weight polyester 1] | 1,570 parts |

The mixture is mixed and kneaded by two rolls at 150° C. for 30 minutes followed by rolling. The mixture is pulverized by a pulverizer (manufactured by Hosokawa Micron Group) to obtain [master batch 1]. The dispersion particle diameter in the master batch is 0.4 μm and particles having a particle diameter of 1 μm or larger is contained therein in an amount of 2% by volume.

### Preparation of Oil Liquid Dispersion 1 of Toner Material

The following components are placed in a beaker and stirred and dissolved.

| | |
|---|---|
| [Prepolymer 1] | 23.4 parts |
| [Low molecular weight polyester] | 123.6 parts |
| [Master batch] | 20 parts |
| Ethyl acetate | 80 parts |

Next, 15 parts of carnauba wax as a releasing agent, 20 parts of carbon black and 120 parts of ethyl acetate are placed and dispersed in a bead mill for 30 minutes. The two solutions are mixed and stirred by a TK type Homomixer at 12,000 rpm for 5 minutes followed by dispersion treatment by the bead mill for 10 minutes. 2.9 parts of isophorone diamine is added to the liquid dispersion and the liquid dispersion is stirred by a TK type Homomixer at 12,000 rpm for 5 minutes to obtain [oil liquid dispersion 1 of toner material].

### Example 1

### Manufacturing of Toner 1

529.5 parts of deionized water, 70 parts of [liquid dispersion of resin particulate 1] and 0.5 parts of dodecyl benzene sodium sulfonate are placed in a beaker. 405.1 parts of [oil liquid dispersion of toner material] is added to the liquid dispersion while stirred by a TK type Homomixer at 12,000 rpm for 30 minutes to conduct reaction. The content is transferred to a flask equipped with a condenser and bathed and aged in hot water. After removing the organic solvent from the aged liquid dispersion, the resultant is filtered, washed, dried and air classified to obtain mother toner having a spherical form. 100 parts of mother toner particles, 0.25 parts of a charge control agent (BONTRONE E-84, manufactured by Orient Chemical industries, Ltd.) are set in a Q type mixer (manufactured by Mitsui Mining Co., Ltd.) and mixed at a circumference speed of a turbine type wing of 50 m/sec. This mixing is conducted with a cycle of 2 minute operation and 1 minute break for 5 cycles (10 minute treatment). 0.5 parts of hydrophobic silica (H2000, manufactured by Clariant Japan KK) is admixed to the mixture. The mixing is conducted with a cycle of 30 second mixing at a circumference speed of 15 m/sec and 1 minute break for 5 cycles to obtain a final product of [toner 1]. The volume average particle diameter, particle size distribution, low temperature fixing property, anti-hot offset property and quality of images are evaluated for [toner 1].

### Example 2

### Manufacturing of Toner 2

Toner 2 is manufactured in the same manner as in Manufacturing of Toner 1 except that the stirring time of TK Homomixer is changed to 60 minutes.

### Example 3

### Manufacturing of Toner 3

Toner 3 is manufactured in the same manner as in Manufacturing of Toner 1 except that the rotation speed of TK Homomixer is changed to 14,000 rpm.

### Example 4

### Manufacturing of Toner 4

Toner 4 is manufactured in the same manner as in Manufacturing of Toner 1 except that the rotation speed of TK Homomixer is changed to 14,000 rpm and the stirring time of TK Homomixer is changed to 60 minutes.

### Example 5

### Manufacturing of Toner 5

Toner 5 is manufactured in the same manner as in Manufacturing of Toner 1 except that the rotation speed of TK Homomixer is changed to 10,000 rpm.

### Example 6

### Manufacturing of Toner 6

Toner 6 is manufactured in the same manner as in Manufacturing of Toner 1 except that the rotation speed of TK Homomixer is changed to 10,000 rpm and the stirring time of TK Homomixer is changed to 30 minutes.

### Example 7

### Manufacturing of Toner 7

Toner 7 is manufactured in the same manner as in Manufacturing of Toner 1 except that the rotation speed of TK Homomixer is changed to 9,000 rpm.

### Example 8

### Manufacturing of Toner 8

Toner 8 is manufactured in the same manner as in Manufacturing of Toner 1 except that the rotation speed of TK Homomixer is changed to 16,000 rpm.

### Example 9

### Manufacturing of Toner 9

Toner 9 is manufactured in the same manner as in Manufacturing of Toner 1 except that the rotation speed of TK Homomixer is changed to 10, 000 rpm and the stirring time of TK Homomixer is changed to 60 minutes.

### Example 10

### Manufacturing of Toner 10

Toner 10 is manufactured in the same manner as in Manufacturing of Toner 1 except that the stirring time of TK Homomixer is changed to 70 minutes.

### Manufacturing Example 2

### Preparation of Oil Liquid Dispersion 2 of Toner Material

The following components are placed in a beaker and stirred and dissolved.

| | |
|---|---|
| [Prepolymer 1] | 23.4 parts |
| [Low molecular weight polyester] | 141.6 parts |
| Ethyl acetate | 80 parts |

Next, 15 parts of carnauba wax as a releasing agent, 20 parts of carbon black and 120 parts of ethyl acetate are placed and dispersed in a bead mill for 30 minutes. The two solutions are mixed and stirred by a TK type Homomixer at 12,000 rpm for 5 minutes followed by dispersion treatment by the bead mill for 10 minutes. 2.9 parts of isophorone diamine is added to the liquid dispersion and the liquid dispersion is stirred by a TK type Homomixer at 12,000 rpm for 5 minutes to obtain [oil liquid dispersion 2 of toner material].

### Comparative Example 1

### Manufacturing of Toner 11

Toner 11 is manufactured in the same manner as in Manufacturing of Toner 1 except that 405.1 parts of [oil liquid dispersion 1 of toner material] is changed to 405.1 parts of [oil liquid dispersion 2 of toner material].

### Comparative Example 2

### Manufacturing of Toner 12

Toner 12 is manufactured in the same manner as in Manufacturing of Toner 1 except that the rotation speed of TK Homomixer is changed to 10,000 rpm and the stirring time of TK Homomixer is changed to 15 minutes.

### Comparative Example 3

### Manufacturing of Toner 13

Toner 13 is manufactured in the same manner as in Manufacturing of Toner 1 except that the rotation speed of TK Homomixer is changed to 12,000 rpm and the stirring time of TK Homomixer is changed to 80 minutes.

### Manufacturing Example 3

### Preparation of Oil Liquid Dispersion 3 of Toner Material

The following components are placed in a beaker and stirred and dissolved.

| | |
|---|---|
| [Prepolymer 1] | 23.4 parts |
| [Low molecular weight polyester] | 141.6 parts |
| Organo silica sol (MEK-ST, solid portion | 7 parts |
| density: 30%, average primary particle | |
| diameter: 15 nm, manufactured by Nissan | |
| Chemical industries, Ltd.) | |
| Ethyl acetate | 64 parts |

Next, 15 parts of carnauba wax as a releasing agent, 20 parts of carbon black and 120 parts of ethyl acetate are placed and dispersed in a bead mill for 30 minutes. The two solutions are mixed and stirred by a TK type Homomixer at 12,000 rpm for 5 minutes followed by dispersion treatment by the bead mill for 10 minutes. 2.9 parts of isophorone diamine is added to the liquid dispersion and the liquid dispersion is stirred by a TK type Homomixer at 12, 000 rpm for 5 minutes to obtain [oil liquid dispersion 3 of toner material].

### Comparative Example 4

### Manufacturing of Toner 14

Toner 14 is manufactured in the same manner as in Manufacturing of Toner 1 except that 405.1 parts of [oil liquid dispersion 1 of toner material] is changed to 405.1 parts of [oil liquid dispersion 3 of toner material].

The characteristics of the toners obtained in Examples 1 to 10 and Comparative Examples 1 to 4 are shown in Table 1.

TABLE 1

| | Particle size | | | | | | | | |
|---|---|---|---|---|---|---|---|---|---|
| | distribution | | | | | | | | |
| | | | Ratio of | | | | | | |
| | | | particle | | | | | | |
| | | | having a | | | | | | |
| | | | diameter | S_{b} | | | | | |
| | | | of 2 μm | (BET | | | | | |
| | | | or | specific | | | | | Glass |
| | | | smaller | surface | | | | Acid | transition |
| | Dv | | (% by | area) | 1/Dv × | | | value | temperature |
| | (μm) | Dv/Dn | number) | (m²/g) | S_{b} | SF-1 | SF-2 | (mgKOH/g) | (° C.) |
| Toner 1 | 5.3 | 1.13 | 2.2 | 2.0 | 0.38 | 130 | 120 | 18.5 | 53.2 |
| Toner 2 | 5.2 | 1.14 | 2.1 | 5.0 | 0.96 | 135 | 126 | 18.4 | 52.4 |
| Toner 3 | 4.2 | 1.15 | 3.4 | 2.5 | 0.60 | 134 | 122 | 18.2 | 53.5 |
| Toner 4 | 4.1 | 1.15 | 3.0 | 4.0 | 0.98 | 138 | 128 | 18.4 | 52.6 |
| Toner 5 | 6.2 | 1.13 | 1.5 | 1.6 | 0.26 | 130 | 122 | 18.2 | 52.2 |
| Toner 6 | 6.1 | 1.13 | 1.0 | 3.0 | 0.49 | 135 | 123 | 18.5 | 53.4 |
| Toner 7 | 7.0 | 1.13 | 1.3 | 1.4 | 0.20 | 134 | 121 | 18.0 | 52.3 |
| Toner 8 | 3.0 | 1.16 | 4.4 | 3.0 | 1.00 | 131 | 120 | 18.1 | 52.1 |
| Toner 9 | 5.8 | 1.13 | 1.0 | 6.0 | 1.03 | 138 | 139 | 18.3 | 53.5 |
| Toner | 5.0 | 1.15 | 2.1 | 7.0 | 1.40 | 135 | 140 | 18.5 | 52.6 |
| 10 | | | | | | | | | |
| Toner | 5.2 | 1.13 | 2.1 | 1.0 | 0.20 | 105 | 106 | 18.2 | 53.0 |
| 11 | | | | | | | | | |
| Toner | 6.9 | 1.15 | 1.4 | 1.0 | 0.14 | 104 | 104 | 18.4 | 52.8 |
| 12 | | | | | | | | | |
| Toner | 5.0 | 1.20 | 3.0 | 7.5 | 1.50 | 141 | 150 | 18.1 | 53.9 |
| 13 | | | | | | | | | |
| Toner | 5.8 | 1.15 | 5.6 | 1.8 | 0.31 | 130 | 137 | 18.3 | 52.9 |
| 14 | | | | | | | | | |

The toners obtained in Examples 1 to 10 and Comparative Examples 1 to 4 are evaluated with regard to the following. The evaluation results are shown in Table 2.

### Evaluation Items and Evaluation Method

Evaluation items and evaluation methods for the toners of Examples and Comparative Examples are shown below.

### Dispersion Particle Diameter (Volume Average Particle Diameter) in Master Batch

### Preparation of Measuring Sample

The master batch and the binder resin are placed in ethyl acetate in which a dispersion agent (Disperbyk-167, manufactured by BYK Chemie) is dissolved in an amount of 5% by weight in such a manner that the ratio of the amount of the organic cation modified laminar mineral in the master batch to the amount of the binder resin used in the master batch is 1/10. The total amount of the master batch and the binder resin is adjusted to be 5% by weight. The prepared sample is stirred fro 12 hours.

### Measuring of Dispersion Particle Diameter

The prepared sample is measured by laser Doppler particle size measuring system.

The measuring method is as follows
Device: nanotrac UPA-150EX (manufactured by Nikkiso Co., Ltd.) Method:
(1) Measuring Conditions of Measuring System

Distribution display: Volume

Number of Channels: 52

Measuring Time: 15 seconds

Refraction Index of Particle: 1.54 at 25° C.

Particle Form: Non-spherical

Viscosity (CP): 0.441

Solvent Refraction Index: 1.37

Solvent: Ethyl acetate
(2) Diluted sample solution to be measured is added to the measuring system while observing the sample Loading (1 to 100) by a dropper or a syringe.
Acid Value (mg/KOH/g)

According to JISK0070. When the sample is not dissolved, another solvent (dioxane, tetrahydrofuran, etc.) is used to dissolve the sample.

The acid value is specifically determined by the following procedure.
Measuring device: automatic potentiometric titrator (DL-53 Titrator manufactured by Mettler Toledo International Inc.)
Electrode: DG113-SC (manufactured by Mettler Toledo International Inc.)
Analysis software: LabX Light Version 1.00.000
Calibration of Device: use a solvent mixture of 120 ml of toluene and 30 ml of ethanol
Measuring temperature: 23° C.

The measuring conditions are as follows:

Stir

| | |
|---|---|
| Speed [%] | 25 |
| Time [s] | 15 |

EQP titration
Titrant/Sensor

| | |
|---|---|
| Titrant | CH₃ONa |
| Concentration [mol/L] | 0.1 |
| Sensor | DG115 |
| Unit of measurement | mV |

Predispensing to volume

| | |
|---|---|
| Volume [mL] | 1.0 |
| Wait time [s] | 0 |

Titrant addition Dynamic

| | |
|---|---|
| dE(set) [mV] | 8.0 |
| dV(min) [mL] | 0.03 |
| dV(max) [mL] | 0.5 |

Measure mode Equilibrium controlled

| | |
|---|---|
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. termination conditions | No |

Evaluation
Procedure Standard

| | |
|---|---|
| Potential 1 | No |
| Potential 2 | No |
| Stop for reevaluation | No |

### Method of Measuring Acid Value

The acid value is measured according to the measuring method described in JIS K0070-1992.

Sample adjustment: 0.5 g of toner (the composition soluble in ethyl acetate: 0.3 g) is added to 120 ml of toluene and the mixture is stirred at room temperature (23° C.) for about 10 hours to dissolve the toner. 30 ml of ethanol is added thereto to prepare a sample solution.

The acid value can be measured by the device described in JIS K0070-1992 and calculated specifically as follows:

Preliminarily standardized N/10 caustic potash-alcohol solution is used for titration and the acid is calculated from the consumption amount of the caustic potash-alcohol solution using the following relationship:

Acid value=KOH (ml)×N×56.1/(weight of sample material), where N represents the factor in N/10 KOH

### Glass Transition Temperature (Tg)

The glass transition temperature can be measured by the following method in which, for example, TG-DSC system TAS-100 (manufactured by Rigaku Corporation) is used: Place about 10 mg of the sample in a sample container made of aluminum; Place the sample container on a holder unit; Set the holder unit in an electric furnace; Heat the electric furnace from room temperature to 150° C. at a temperature rising speed of 10° C./min; Leave it at 150° C. for 10 minutes; Cool down the sample to room temperature and leave it for 10 minutes; Thereafter, heat the sample to 150° C. at a temperature descending speed of 10° C./min; Measure the DSC curve by a differential scanning calorimeter (DSC); and, from the obtained DSC curve, calculate the glass transition temperature (Tg) from the intersection point of a tangent of the endothermic curve around the glass transition temperature (Tg) and the base line using the analysis system installed in TAS-100 system.

### Image Density

After 150,000 image charts having an image ratio of 50% are output in a single color mode using a digital full color photocopier (imagioColor2800, manufactured by Ricoh Co., Ltd.), a solid image is output to 6000 paper (manufactured by Ricoh Co., Ltd.). The image density of the solid image is measured by Xrite (manufactured by X-Rite, Incorporated).

This is separately performed for each of four colors and the average is obtained.

The evaluation criteria are as follows:

Less than 1.2: B (Bad)

1.2 to less than 1.4: F (Fair)

1.4 to less than 1.8: G (Good)

1.8 to less than 2.2: E (Excellent)

### Image Roughness, Vividness and Sharpness

Image roughness, vividness and sharpness are evaluated by observing a single color photograph printed by a digital full color photocopier (imagioColor2800, manufactured by Ricoh Co., Ltd.) with naked eyes. The evaluation criteria are as follows:
E (Excellent): as good as offset printing
G (Good): slightly inferior to offset printing
B (Bad): significantly worse than offset printing
W (Worse): same as typical electrophotographic image (Extremely bad)

### Background Fouling

30,000 images having 50% image area in a single color mode are output using a digital full color photocopier (imagioColor2800, manufactured by Ricoh Co., Ltd.). A white solid image is developed but developing the white solid image is stopped in the middle of development. The developing agent on the photoreceptor is transferred to a tape after the white solid image is developed. The image density of the tape and a tape to which no developing agent is transferred is measured by 938 spectrodensitometer (manufactured by X-rite, Incorporated) to see the difference therebetween. The smaller the difference, the better the degree of background fouling. The degree of background fouling is evaluated as E (Excellent), G (Good), F (Fair) and P (Poor).

### Toner Scattering

50,000 images are continuously printed using a digital full color photocopier (imagioColor2800, manufactured by Ricoh Co., Ltd.) and then the degree of contamination by toner in the photocopier is checked. The degree of contamination by toner is evaluated as follows:

G (Good): no problem

F (Fair): toner observed with no practical problem

B (Bad): significantly contaminated, which causes problem

### Cleaning Property

The toner still remaining on the photoreceptor after the cleaning process is transferred by a Scotch Tape (manufactured by Sumitomo 3M Co., Ltd.) to white paper. The density on the white paper is measured by a Macbeth reflection densitometer RD514 (manufactured by X-Rite Incorporated). The evaluation criteria are as follows:
G (Good): 0.01 or lower (difference) when compared with a blank image
B (Bad): higher than 0.01 (difference) when compared with a blank image

### Evaluation on Chargeability

### 1) Amount of Charge (15 Second Stirring)

10 g of the obtained toner and 100 g of ferrite carrier are placed in a stainless steel pot to 30% by volume thereof in the environment of 28° C. and 80% humidity. The mixture is stirred at 100 rpm for 15 seconds and the amount of charge (μC/g) of the developing agent is measured by TB-200 (manufactured by Kyocera Chemical Corporation).

The amount of charge of the toner is measured by a blow-off method

### 2) Amount of Charge (5 Minute Stirring)

Amount of charge measured in the same manner as in 1) except that the stirring time is changed to 5 minutes

### 3) Amount of Charge (10 Minute Stirring)

Amount of charge measured in the same manner as in 1) except that the stirring time is changed to 10 minutes

### Charging Stability

### (1) Charging Stability in Environment of High Temperature and High Humidity

While outputting 100,000 single color images having a 7% image area at 40° C. and 90% humidity by using a digital full color photocopier (imagioColor2800, manufactured by Ricoh Co., Ltd.), part of the developing agent is sampled per 1,000 image outputs and the amount of charge thereof is measured by a blow-off method to evaluate the charging stability. The evaluation criteria are as follows:
G (Good): when the variance in the amount of charge is 5 μC/g or less
F (Fair): when the variance in the amount of charge is greater than 5 μC/g and not greater than 10 μC/g
B (Bad): when the variance in the amount of charge is greater than 10 μC/g

### (2) Charging Stability in Environment of Low Temperature and Low Humidity

While outputting 100,000 single color images having a 7% image area at 10° C. and 15% humidity by using a digital full color photocopier (imagioColor2800, manufactured by Ricoh Co., Ltd.), part of the developing agent is sampled per 1,000 image outputs and the amount of charge thereof is measured by a blow-off method to evaluate the charging stability. The evaluation criteria are as follows:
G (Good): when the variance in the amount of charge is 5 μC/g or less
F (Fair): when the variance in the amount of charge is greater than 5 μC/g and not greater than 10 μC/g
B (Bad): when the variance in the amount of charge is greater than 10 μC/g

### The Blow-Off Method for Use in 1) and 2) is as Follows:

10 g of each toner and 100 g of ferrite carrier are placed in a stainless steel pot to 30% by volume thereof in an environment of 20° C. and 50% humidity. The mixture is stirred at 100 rpm for 10 minutes and the amount of charge (μC/g) of the developing agent is measured by TB-200 (manufactured by Kyocera Chemical Corporation).

### Evaluation on Fixing Property

Photocopying test is performed using an apparatus remodeled based on MF2200 (manufactured by Ricoh Co., Ltd.) in which the fixing device is changed to a fixing device using Teflon® roller as the fixing roller. TYPE 6200 paper (manufactured by Ricoh Co., Ltd.) is set in the apparatus for a photocopying test. Cold offset temperature (lowest fixing temperature) and hot offset temperature (anti-hot offset temperature) are obtained changing the fixing temperature. The lowest fixing temperature is typically from about 140 to about 150° C. The evaluation conditions on the low temperature fixing are as follows: Paper feeding linear speed: 120 to 150 mm/sec.; Surface pressure: 1.2 Kgf/cm²; Nip width: 3 mm. The evaluation conditions on the high temperature offset are as follows: Paper feeding linear speed: 50 mm/sec.; Surface pressure: 2.0 Kgf/cm²; Nip width: 4.5 mm. The evaluation criteria for each characteristic are as follows:

### (1) Cold Offset Property (Low Temperature Fixing Property: 5 Levels)

E (Excellent): lower than 140° C.

G (Good): 140 to 149° C.

F (Fair): 150 to 159° C.

B (Bad): 160 to 170° C.

W (Worse): 170° or higher

### (2) Hot Offset Property (5 Levels)

E (Excellent): 201° C. or higher

G (Good): 191 to 200° C.

F (Fair): 181 to 190° C.

B (Bad): 171 to 180° C.

W (Worse): 170° or lower

### High Temperature Preservability

The toner is preserved at 50° C. for 8 hours followed by sieving with 42 meshes for 2 minutes. The remaining ratio of the toner on metal mesh is determined as the high temperature preservability. A toner having a good high temperature preservability has a small remaining ratio. The evaluation criteria are the following four levels:

B (Bad): 30% or higher

F (Fair): 20% to less than 30%

G (Good): 10% to less than 20%

E (Excellent): Less than 10%

TABLE 2

| | | | | | | | | | Charging | Charging | | | |
|---|---|---|---|---|---|---|---|---|---|---|---|---|---|
| | | Image | | | | | | | stability | stability | | | |
| | | (rough | | | | | | | (high | (low | Cold | High | |
| | | vivid | | | | Amount of charge | | | temp. and | temp. and | offset | offset | High |
| | Image | and | Background | Toner | Cleaning | 15 | | | high | low | temp. | temp. | temp. |
| | density | sharp) | fouling | scattering | property | sec | 5 min | 10 min | humidity) | humidity) | (° C.) | (° C.) | preservability |
| Ex. 1 | E | E | E | G | G | −43.5 | −45.1 | −46.2 | G | G | 130: E | 210: E | G |
| Ex. 2 | E | E | E | G | G | −43.1 | −44.3 | −40.2 | G | G | 140: G | 210: E | G |
| Ex. 3 | E | E | E | G | G | −40.3 | −42.9 | −41.8 | G | G | 130: E | 210: E | G |
| Ex. 4 | E | E | E | G | G | −38.2 | −40.8 | −40.0 | G | G | 140: G | 210: E | G |
| Ex. 5 | G | G | G | G | G | −37.2 | −39.4 | −40.4 | G | G | 140: G | 210: E | G |
| Ex. 6 | G | G | G | G | G | −41.2 | −43.8 | −44.3 | G | G | 140: G | 210: E | G |
| Ex. 7 | G | G | G | G | G | −40.2 | −41.2 | −44.2 | G | G | 140: G | 210: E | G |
| Ex. 8 | E | E | E | G | G | −41.2 | −43.8 | −44.3 | G | G | 140: G | 210: E | G |
| Ex. 9 | E | E | E | G | G | −45.5 | −48.3 | −47.2 | G | G | 140: G | 210: E | G |
| Ex. | E | E | E | G | G | −44.3 | −45.2 | −46.1 | G | G | 140: G | 210: E | G |
| 10 | | | | | | | | | | | | | |
| Comp. | E | E | P | B | B | −20.3 | −23.3 | −24.5 | F | F | 140: G | 200: G | B |
| Ex. 1 | | | | | | | | | | | | | |
| Comp. | F | G | P | B | B | −30.5 | −31.1 | −32.8 | F | F | 140: G | 200: G | G |
| Ex. 2 | | | | | | | | | | | | | |
| Comp. | G | W | F | F | G | −47.1 | −48.3 | −48.9 | F | B | 145: G | 200: G | B |
| Ex. 3 | | | | | | | | | | | | | |
| Comp. | F | B | F | F | G | −36.2 | −38.7 | −40.8 | F | F | 145: G | 210: E | G |
| Ex. 4 | | | | | | | | | | | | | |

This document claims priority and contains subject matter related to Japanese Patent Application No. 2007-308612, filed on Nov. 29, 2008, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising:
a binder resin;
a coloring agent;
a releasing agent; and
a modified laminar inorganic mineral;
wherein the toner is granulated by dispersing the coloring agent, the releasing agent, the modified laminar inorganic mineral and at least one of the binder resin and a precursor thereof in an organic solvent to form an oil phase, dispersing the oil phase in an aqueous medium to obtain a dispersion emulsion and removing solvents therefrom, and
wherein the toner satisfies the following relationship (1):
0.2≦{1/Dv (μm)}×S_{b} (m²/g)≦1.4 Relationship (1)
where Dv represents a volume average particle diameter of the toner, and S_{b} represents a BET specific surface area of the toner.

2. The toner according to claim 1, wherein the oil phase comprises a complex of kneaded mixture of the releasing agent and the modified laminar inorganic mineral.

3. The toner according to claim 1, wherein the toner has a BET specific surface area of from 1.0 to 7.0 m²/g.

4. The toner according to claim 1, wherein the toner has a volume average particle diameter is from 3 to 7 μm.

5. The toner according to claim 2, wherein the modified laminar inorganic mineral in the complex has a volume average diameter Dv of from 0.1 to 0.55 μm and the modified laminar inorganic mineral having a particle diameter of not less than 1 μm in the complex is not greater than 15% by volume.

6. The toner according to claim 1, wherein a content of the modified laminate mineral inorganic mineral is 0.1 to 5% by weight based on the toner.

7. The toner according to claim 1, wherein organic ions for use in modification of the modified laminar inorganic mineral is quaternary ammonium ion.

8. The toner according to claim 1, wherein a ratio (Dv/Dn) of the volume average particle diameter Dv to a number average particle diameter Dn is not greater than 1.20.

9. The toner according to claim 1, comprising toner particles having a particle diameter of not greater than 2 μm in an amount of from 1 to 10% by number.

10. The toner according to claim 1, wherein the binder resin comprises a polyester resin.

11. The toner according to claim 10, wherein a content of the polyester resin in the binder resin is from 50 to 100% by weight.

12. The toner according to claim 10, wherein the polyester resin comprises a portion soluble in tetrahydrofuran (THF) which has a weight average molecular weight of from 1,000 to 30,000.

13. The toner according to claim 10, wherein the polyester resin has an acid value of from 1.0 to 50.0 mgKOH/g.

14. The toner according to claim 10, wherein the polyester resin has a glass transition temperature of from 35 to 65° C.

15. The toner according to claim 1, wherein the precursor has a weight average molecular weight is from 3,000 to 20,000.

16. The toner according to claim 1, wherein the toner has an acid value of from 0.5 to 40.0 mgKOH/g.

17. The toner according to claim 1, wherein the toner has a glass transition temperature of from 40 to 70° C.

18. The toner according to claim 1, wherein the toner is for use in a two component developing agent.

19. A method of manufacturing the toner of claim 1 comprising:
dispersing a coloring agent, a releasing agent, a modified laminar inorganic mineral and at least one of a binder resin and a precursor thereof in an organic solvent to obtain an oil phase comprising a liquid dispersion;
dispersing the oil phase in an aqueous medium to obtain a dispersion emulsion; and
removing a solvent from the dispersion emulsion to granulate toner particles.

20. An image formation method comprising:
charging an image bearing member to uniformly charge a surface thereof;
irradiating the surface of the image bearing member with light to form a latent electrostatic image thereon;
developing the latent electrostatic image with the toner of claim 1 to form a toner image on the surface of the image bearing member;
transferring the toner image borne on the image bearing member to a transfer medium; and
removing the toner remaining on the surface of the image bearing member with a blade.
